(19) United States
(12) Patent Application Publication
(10) Pub. No.: US 2023/0017977 A1
(43) Pub. Date: Jan. 19, 2023

(54) SOLID STATE BATTERY COMPRISING SILICON (Si) AS NEGATIVE ELECTRODE ACTIVE MATERIAL

(71) Applicants: LG ENERGY SOLUTION, LTD., Seoul (KR); THE REGENTS OF THE UNIVERSITY OF CALIFORNIA, Oakland, CA (US)

(72) Inventors: Jeong-Beom LEE, Daejeon (KR); Hye-Ri JUNG, Daejeon (KR); Hyea-Eun HAN, Daejeon (KR); Hoe-Jin HAH, Daejeon (KR); Sung-Rok BANG, Daejeon (KR); Ying Shirley MENG, La Jolla, CA (US); Huan Shen Darren TAN, La Jolla, CA (US)

(73) Assignees: LG ENERGY SOLUTION, LTD., Seoul (KR); THE REGENTS OF THE UNIVERSITY OF CALIFORNIA, Oakland, CA (US)

(21) Appl. No.: 17/946,250

(22) Filed: Sep. 16, 2022

Related U.S. Application Data
(63) Continuation-in-part of application No. PCT/KR2021/003459, filed on Mar. 19, 2021.
(60) Provisional application No. 63/037,667, filed on Jun. 11, 2020.
(60) Provisional application No. 63/157,012, filed on Mar. 5, 2021.

(51) Int. Cl. H01M 4/38; H01M 10/0525; H01M 10/0562; H01M 4/40; H01M 10/058

(52) U.S. Cl. CPC H01M 4/386; H01M 10/0525; H01M 10/0562; H01M 4/405; H01M 10/058; H01M 2004/027

(57) ABSTRACT

A solid state battery is described, which has a negative electrode having a negative electrode active material layer including silicon (Si) as a negative electrode active material. The Si may be present as particles, e.g., microparticles, having an average particle size (D50) of 0.1 μm to 10 μm. The negative electrode active material layer may include the silicon (Si) in an amount of 75 wt % or more, 95 wt % or more, 99 wt % or more, or 99.9 wt % or more, based on 100 wt % of the negative electrode active material layer. The negative electrode active material layer can be free or substantially free of conductive material, carbon, solid state electrolyte, and/or binder. Preferably, after charge/discharge cycles, the negative electrode active material layer forms densified and interconnected large particles of Li—Si alloy, e.g., the Li—Si alloy may have at least one columnar structure and at least one void.

### RELATED APPLICATIONS

The present application is a Continuation-In-Part of PCT/KR2021/003459, filed Mar. 19, 2021 and claims the benefit of U.S. Provisional Application No. 63/037,667 filed on Jun. 11, 2020 and U.S. Provisional Application No. 63/157,012 filed on Mar. 5, 2021, the disclosures of which are expressly incorporated herein by reference in their entirety.

### TECHNICAL FIELD

The present disclosure relates to a negative electrode for a solid state battery and a solid state battery comprising the negative electrode.

### BACKGROUND ART

The conventional lithium ion secondary battery uses a transition metal oxide-based positive electrode active material and a graphite-based negative electrode active material, and uses a liquid electrolyte to ensure lithium ionic conductivity between the positive electrode and the negative electrode.

Recently, there are increasing studies of high capacity negative electrode active material, such as silicon (Si), as an alternative to the graphite-based negative electrode active material. Silicon (Si) has high electrical conductivity and exhibits higher capacity characteristics than the graphite-based active material. So, when silicon (Si) is applied as the negative electrode active material, it is possible to achieve higher battery capacity and smaller battery size than the existing batteries including the graphite-based negative electrode.

However, silicon (Si) has a large volume change during charge/discharge, and as a consequence, fracture frequently occurs. When a fracture occurs, a new surface is exposed by the fracture, and when the new surface contacts the liquid electrolyte, a solid electrolyte interphase (SEI) layer is formed on the surface, resulting in reduced battery capacity. To mitigate the capacity fade, attempts have been made to add a variety of Si nanostructures to the silicon (Si) negative electrode in combination with carbon composites and a binder material to mitigate pulverization and Si prelithiation to compensate for Li loss. Alternatively, studies have been made to form LiF/LiOH/Li₂O using fluoroethylene carbonate (FEC) or other ionic liquid additive. However, despite these continuous studies, it is still difficult to enable stable cycling beyond 100 cycles in full cells and new approaches are needed. Additionally, to realize high energy density, it is necessary to study approaches to reduce the binder and carbon conductive additive ratios.

### DISCLOSURE

### Technical Problem

The present disclosure is directed to providing a solid state battery using silicon (Si) as a negative electrode active material. Additionally, the present disclosure is further directed to providing a solid state battery having good electrical and chemical properties including heat resistant stability, energy density, life characteristics and Coulombic efficiency. It will be readily appreciated that these and other objects and advantages of the present disclosure may be realized by means or methods described in the appended claims and a combination thereof.

### Technical Solution

A first aspect of the present disclosure relates to a solid state battery, where the solid state battery comprises a negative electrode, a positive electrode and a solid electrolyte layer interposed between the negative electrode and the positive electrode, wherein the negative electrode comprises a current collector and a negative electrode active material layer, wherein the solid electrolyte layer comprises a solid electrolyte, and wherein the negative electrode comprises a negative electrode active material layer comprising silicon (Si) as a negative electrode active material, and wherein after one or more charge/discharge cycle, the negative electrode active material layer forms a Li—Si alloy having at least one columnar structure and at least one void. In some embodiments, the Si in the negative electrode active material layer reacts to form a Li—Si alloy, which may be in the form of Li—Si-alloy particles, which may be interconnected and densified, and may further form at least one columnar structure. Voids may exist between respectively columnar structures. In some embodiments, the negative electrode active material layer comprises the silicon (Si) in an amount of 75 wt % or more based on 100 wt % of the negative electrode active material layer. In some embodiments, the solid electrolyte layer comprises an inorganic-based electrolyte and/or an organic-based electrolyte. For instance, the solid electrolyte can be an inorganic electrolyte selected from the group consisting of a sulfide-based solid electrolyte, an oxide-based solid electrolyte, a halide-based solid electrolyte, and a hydride-based solid electrolyte, or an organic-based electrolyte selected from the group consisting of a gel electrolyte, and a polymer-based electrolyte.

In another aspect of the present disclosure, the negative electrode active material layer further comprises at least one of lithium, conductive material, binder, and solid state electrolyte.

In another aspect of the present disclosure, after one or more charge/discharge cycle, the negative electrode active material layer forms a Li—Si alloy having at least one columnar structure and at least one void. In certain embodiments, the at least one void has a height that is 75-100% of the distance between the current collector and the solid electrolyte layer. In certain embodiments, the negative electrode active material layer comprising the Li—Si alloy having at least one columnar structure and at least one void has an electronic conductivity between 10⁴ to 10⁻⁰ S cm⁻¹. In certain embodiments, the negative electrode active material layer in the discharged state comprising the Li—Si alloy (having at least one columnar structure and at least one void) has a density between 50-90%. In certain embodiments, the negative electrode active material layer in the discharged state comprising the Li—Si alloy (having at least one columnar structure and at least one void) has a porosity between 10-50%.

In another aspect of the present disclosure, the negative electrode active material layer comprises the silicon (Si) in an amount of 75 wt % or more, preferably 90 wt % or more based on 100 wt % of the negative electrode active material layer. Preferably, the solid state battery has a negative electrode active material layer that comprises the silicon (Si) in an amount of 95 wt % or more based on 100 wt % of the negative electrode active material layer. Preferably, the solid state battery has a negative electrode active material layer that comprises the silicon (Si) in an amount of 99 wt % or more based on 100 wt % of the negative electrode active material layer. More preferably, the solid state battery has a negative electrode active material layer that comprises the silicon (Si) in an amount of 99.9 wt % or more based on 100 wt % of the negative electrode active material layer.

In another aspect of the present disclosure, the solid electrolyte is an inorganic based electrolyte or an organic based electrolyte. The inorganic electrolyte may be selected from the group consisting of a sulfide-based solid electrolyte, an oxide-based solid electrolyte, a halide-based solid electrolyte, and a hydride-based solid electrolyte. For instance, the solid electrolyte may be a sulfide-based solid electrolyte, which comprises at least one selected from LPS-based glass or glass ceramic (xLi₂S.yP₂S₅), where x+y=1, and y=1 to x, preferably x ranges from 0.4-0.8, most preferably x=0.8, preferably y ranges from 0.2-0.6, most preferably y=0.2, or argyrodite-based sulfide-based solid electrolyte (Li₆PS₅X; X=Cl, Br, or I).

In another aspect of the present disclosure, the silicon (Si) may be present as particles having an average particle size (D50) of 0.1 μm to 10 μm.

In another aspect of the present disclosure, the negative electrode active material layer has a porosity at a state before first charge/discharge cycle (e.g., a pristine state) of 25 vol % to 65 vol %.

In another aspect of the present disclosure, the negative electrode active material layer has a porosity at a pristine state of 25 vol % to 40 vol %.

In another aspect of the present disclosure, the negative electrode active material layer has a porosity of equal to or less than 10 vol % at SOC of 90% to 100%.

In another aspect of the present disclosure, silicon (Si) having a purity of 97% or more may be introduced as the negative electrode active material.

In another aspect of the present disclosure, the positive electrode comprises a positive electrode active material layer, the positive electrode active material layer comprises lithium transition metal composite oxide as a positive electrode active material, and the transition metal comprises at least one of Co, Mn Ni or Al.

In another aspect of the present disclosure, the positive electrode active material layer further comprises at least one of a binder resin, a conductive material or a solid electrolyte.

In another aspect of the present disclosure, the solid electrolyte layer comprises a sulfide-based solid electrolyte, and the sulfide-based solid electrolyte comprises at least one selected from LPS-based glass or glass ceramic (xLi₂S.yP₂S₅, as defined above), or argyrodite-based sulfide-based solid electrolyte (Li₆PS₅X; X=Cl, Br, or I).

In another aspect of the present disclosure, the lithium transition metal composite oxide comprises at least one of compounds represented by the following Formula 1:

LiₓNiₐCo_{b}Mn_{c}M_{z}O_{y} [Formula 1]

where 0.5≤x≤1.5, 0<a≤1, 0≤b<1, 0≤c<1, 0≤z<1, 1.5<y<5, a+b+c+z is 1 or less, and M comprises at least one selected from Al, Cu, Mg, B and combinations thereof.

In another aspect of the present disclosure, in Formula 1 above, the a is 0.5 or more and equal to or less than 1.

In another aspect of the present disclosure of the lithium transition metal composite oxide, the lithium transition metal composite oxide comprises LiNi_{0.8}Co_{0.1}Mn_{0.1}O₂.

In another aspect of the present disclosure, the positive electrode active material layer is obtained using the positive electrode active material, the conductive material, the binder resin and the solid electrolyte by a manufacturing method according to a dry mixing process without a solvent.

In another aspect of the present disclosure, the negative electrode active material layer comprises no conductive material or is substantially free of conductive material.

In another aspect of the present disclosure, the negative electrode active material layer comprises no solid state electrolyte or is substantially free of solid state electrolyte.

In another aspect of the present disclosure, the negative electrode active material layer comprises no binder or is substantially free of binder.

In another aspect of the present disclosure, the negative electrode active material layer comprises no carbon-based conductive material or is substantially free of a carbon-based conductive material. Preferably, the negative electrode active material layer is substantially free of conductive material, carbon, solid state electrolyte, and/or binder.

In another aspect of the present disclosure, the battery has a negative/positive capacity ratio (NP ratio) of 0.1 to 30.0.

In another aspect of the present disclosure, the negative electrode active material layer further comprises at least one of lithium, conductive material, binder, and solid state electrolyte.

Another aspect of the present disclosure relates to the solid state battery in any one of the above aspects, wherein the negative electrode active material layer further comprises at least one of lithium, conductive material, binder, and solid state electrolyte. For instance, 0-25 wt % lithium, 0 to less than 20 wt % conductive material, 0-25 wt % binder (e.g., polymeric binder), and 0-25 wt % solid state electrolyte based upon the total weight of the negative electrode active material layer. In an exemplary, but non-limiting description, the negative electrode active material layer may further comprise the lithium, the binder and the solid state electrolyte in respective amounts of 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, 19 wt %, 20 wt %, 21 wt %, 22 wt %, 23 wt % or 24 wt % including any combination thereof. In an exemplary, but non-limiting description, the negative electrode active material layer may further comprise the conductive material in amounts of 1 wt %, 2 wt %, 3 wt %, 4 wt %, 5 wt %, 6 wt %, 7 wt %, 8 wt %, 9 wt %, 10 wt %, 11 wt %, 12 wt %, 13 wt %, 14 wt %, 15 wt %, 16 wt %, 17 wt %, 18 wt %, or 19 wt % including any combination thereof.

In one embodiment, when the negative electrode active material layer further comprises lithium, conductive material, binder, and/or solid state electrolyte, these are present in amounts that do not interfere with the formation of Li—Si (through the reaction mechanism of Si+Li→Li—Si) to form the specific morphology (columnar structure). In certain aspects, the volume ratio of lithium, conductive material, binder, and/or solid state electrolyte in certain embodiments may be less than 5 wt %, less than 4 wt %, less than 3 wt %, less than 2 wt %, less than 1 wt % relative to the volume of the negative electrode active material.

The negative electrode active material layer may comprise 0-25 wt % lithium at the discharged state. During charge of the battery, Li+ may travel from the cathode to the silicon anode, and during discharge, it may be that not all the Li+ returns to the cathode, with some remaining at the anode. The lithium may be in the pristine state, in either the elemental form (Li) or ionic form (Li+).

Another aspect of the present disclosure relates to the solid state battery in any one of the above aspects, wherein the negative electrode active material layer in a discharged state comprising the Li—Si alloy (having at least one columnar structure and at least one void) has an electronic conductivity between 10⁴ to 10⁻⁰ S cm⁻¹. The electronic conductivity may be carried out by any suitable method to measure electronic conductivity of bulk materials, including for example, a direct current (DC) polarization method.

Another aspect of the present disclosure relates to the solid state battery in any one of the above aspects, wherein the negative electrode active material layer in a discharged state comprises the Li—Si alloy has a density between 50-90%, preferably a density between 60-80%, preferably a density between 65-85%, and preferably a density of 70%.

Another aspect of the present disclosure relates to the solid state battery in any one of the above aspects, wherein the negative electrode active material layer in a discharged state comprises the Li—Si alloy has a porosity between 10-50%, preferably a porosity between 20-40%, preferably a porosity between 25-35%, and preferably a porosity of 30%.

Another aspect of the present disclosure relates to the solid state battery in any one of the above aspects, wherein prior to battery operation, the negative electrode comprises a negative electrode active material layer comprising silicon (Si) as a negative electrode active material, the negative electrode active material layer comprises the silicon (Si) in an amount of 75 wt. % or more based on 100 wt. % of the negative electrode active material layer, and wherein after operation of the battery for one or more cycles, the negative electrode active material layer forms a Li—Si alloy, the Li—Si alloy forming at least one columnar structure.

Another aspect of the present disclosure relates to the solid state battery in any one of the above aspects, comprising a negative electrode, a positive electrode and a solid electrolyte layer interposed between the negative electrode and the positive electrode, wherein prior to charge and discharge of the battery, the negative electrode comprises a negative electrode active material layer comprising silicon (Si) as a negative electrode active material in an amount of 75 wt % or more based on 100 wt % of the negative electrode active material layer, wherein after a charge/discharge cycle, the negative electrode active material layer forms a structure having particles comprising a Li—Si alloy, the Li—Si alloy forming one or more columnar structures, and wherein after operation of the battery for 200 cycles, a change in a thickness of the negative electrode active material layer at the discharged state is less than 25%. In a preferred embodiment, after operation of the battery for 1000 cycles, a change in a thickness of the negative electrode active material layer at the discharged state is less than 25%.

Another aspect of the present disclosure relates to a solid state battery according to any of the above aspects, wherein a thickness of the negative electrode active material layer follows the below formula:

$$1 \leq \frac{B}{A} \leq 1.25$$

wherein A is a thickness of the negative electrode active material layer after N (N is a certain natural number) charge/discharge cycle, B is a thickness of the negative electrode active material layer after N+100 charge/discharge cycle. Another aspect of the present disclosure relates to a solid state battery according to any of the above aspects, wherein N is an integer from 1 to 1000, preferably 1 to 800, preferably 1 to 500.

Another aspect of the present disclosure relates to a solid state battery according to any of the above aspects, wherein the negative electrode active material layer in a discharged state comprising the Li—Si alloy (having a columnar structure and at least one void), wherein the Li—Si alloy has an interfacial layer that is at least partially in contact with the solid electrolyte, and wherein the at least one void between the columnar structure is located between the current collector and the solid electrolyte layer. For instance, the at least one void can be located between the current collector and the interfacial layer.

Another aspect of the present disclosure relates to a method for manufacturing the solid state battery in any one of the above aspects, which comprises providing a negative electrode, a positive electrode and a solid electrolyte layer interposed between the negative electrode and the positive electrode, wherein the negative electrode comprises a negative electrode active material layer comprising silicon (Si) as a negative electrode active material, and the negative electrode active material layer comprises the silicon (Si) in an amount of 75 wt. % or more based on 100 wt. % of the negative electrode active material layer.

Another aspect of the present disclosure relates to a solid state battery comprising: a negative electrode, a positive electrode and a solid electrolyte layer interposed between the negative electrode and the positive electrode, wherein the negative electrode comprises a current collector and a negative electrode active material layer, wherein the solid electrolyte layer comprises a solid electrolyte, wherein the negative electrode active material layer comprises silicon (Si) as a negative electrode active material in amount of 75 wt % or more based on 100 wt % of the negative electrode active material layer, and wherein the negative electrode active material layer is substantially free of solid state electrolyte. In another aspect of the present disclosure the negative electrode active material layer further comprises at least one of lithium, conductive material, and binder.

### Advantageous Effects

The solid state battery according to the present disclosure may have high energy density due to the high amount of the negative electrode active material Si in the negative electrode. Additionally, the negative electrode may exhibit the porous characteristics attributed the pores by the space between Si particles before charge/discharge cycles, and the pores reduce the volume change of Si particles during charge/discharge. Additionally, using the Si negative electrode and the inorganic electrolyte, when fracture occurs in Si particles due to the volume change, a solid electrolyte interphase (SEI) layer may not be formed on a new surface formed by the fracture, thereby preventing the loss of the active material and maintaining the battery capacity, as well as avoiding the impedance rise. With these features, the battery according to the present disclosure may have good electrical and chemical properties including heat resistant stability, energy density, life characteristics and Coulombic efficiency.

### BRIEF DESCRIPTION OF THE DRAWINGS

The accompanying drawings illustrate a preferred embodiment of the present disclosure, and together with the detailed disclosure, serve to provide a further understanding of the technical aspects of the present disclosure, and the present disclosure should not be construed as being limiting to the drawings. In the drawings, for clarity of description, the shape, size, scale or proportion of the elements may be exaggerated for emphasis.

FIGS. 1a and 1b are diagrams showing a difference in solid electrolyte interphase (SEI) layer forming mechanism by the fracture of the negative electrode active material in the conventional liquid electrolyte battery (1a) and a solid electrolyte battery (1b) of the present disclosure.

FIG. 1c shows the lithiation mechanism of a negative electrode during cycles in the negative electrode of a solid state battery of the present disclosure.

FIG. 2 shows an X-ray diffraction pattern of a mixture of a sulfide-based solid electrolyte and Si powder.

FIGS. 3a and 3b are cross-sectional views of a solid state battery according to example 1-1, and they are scanning electron microscope (SEM) images showing the states before cycles (3a) and after cycles (3b).

FIG. 4a shows a digital image of a Si negative electrode according to example 1-1 of the present disclosure, and FIGS. 4b and 4c show SEM images at each magnification scale.

FIGS. 5a to 5c show Voltage profile (5a), cycle performance and average Coulombic efficiencies (5b) according to examples 1-1, 1-2 and 1-3 of the present disclosure and a charge/discharge profile (5c) at c/3 rate for the battery of example 1-1.

FIG. 6 shows voltage profile during initial lithiation of batteries of example 1-1 and comparative example 1.

FIG. 7 shows lithiated diffraction patterns of Si-Solid State Electrolytes (SSE) and lithiated Si-SSE of the battery of example 1-1 before cycles and lithiated diffraction patterns of comparative example 1.

FIGS. 8a to 8c show Si-SSE interface products using AXIS Supra X-ray photoelectron spectroscopy (XPS) (Kratos Analytical) in the batteries of example 1-1 and comparative example 1, and a difference between the presence and absence of carbon additive in the charging of the battery.

FIGS. 9a to 9c show the quantification of formed SEI and Li—Si using Titration Gas Chromatography (TGC) method in the battery of example 1-1.

FIGS. 10a to 10d show a comparison in life characteristics between the battery of example 1-1 and the battery of comparative example 2.

FIGS. 11a to 11d show the storage characteristics in room temperature and high temperature conditions of example 1-1 and comparative example 2.

FIGS. 12a to 12d show the measured electrochemical impedance spectroscopy (EIS) of the battery of example 1-1.

FIGS. 13a and 13b show charge/discharge graphs of the batteries according to comparative example 3 (13a) and example 2 (13b) of the present disclosure.

FIGS. 14a to 14d are SEM images of a positive electrode manufactured by a dry method in example 1-1.

FIGS. 15a to 15c show EDS images of a positive electrode manufactured in example 1-1.

FIG. 16 shows Areal capacity as a function of rate change in the battery manufactured in example 1-1.

FIG. 17 shows the changes in Areal capacity and Coulombic efficiency of the battery manufactured in example 1-1 at 1C during 30 cycles.

FIGS. 18a to 18c show the morphology changes upon lithiation and delithiation of 99.9 wt. % Si. The dotted box represents enlarged porous regions of interest for each sample. FIG. 18a shows pristine porous microstructure of the μSi electrode. FIG. 18b shows the charged state with densified interconnected Li—Si structure. FIG. 18c shows the discharged state with void formation between large dense Si particles.

FIGS. 19a to 19c show SEM cross section images of μSi anode electrode with ˜3.8 mg Si cm⁻² mass loading. In FIG. 19a, a pristine electrode of 27 μm in thickness has a porosity of 40%. In FIG. 19b, the charged state shows a dense Li—Si layer formation that is 55 μm in thickness. In FIG. 19c, the discharged state of 40 μm in thickness shows void formation between large silicon particles. All three electrodes were punched from the same batch.

FIGS. 20a to 20c show SEM cross section images of ˜1.9 mg Si cm′ electrodes. FIG. 20a shows the 1st delithiated cycle, FIG. 20b shows the 100th delithiated cycle, and FIG. 20c shows the 200th delithiated cycle. Despite the interparticle voids formed at the full cell's discharged state due to volume changes, the morphologies and thicknesses of the particles are retained.

FIGS. 21a to 21c show the electrochemical data of carbon-containing silicon. As can be seen, increasing the amount of carbon may lower the first cycle Coulombic Efficiency (CE) and capacity utilization.

### DETAILED DESCRIPTION

Hereinafter, the present disclosure will be described in detail. Prior to the description, it should be understood that the terms or words used in the specification and the appended claims should not be construed as limited to general and dictionary meanings, but rather interpreted based on the meanings and concepts corresponding to the technical aspects of the present disclosure on the basis of the principle that the inventor is allowed to define terms appropriately for the best explanation. Therefore, the embodiments described herein and the elements shown in the drawings is just a most preferred embodiment of the present disclosure, but not intended to fully describe the technical aspects of the present disclosure, so it should be understood that other equivalents and modifications could have been made thereto at the time the application was filed.

The term “comprise(s)” or “include(s)” when used in this specification, specifies the presence of stated elements, but does not preclude the presence or addition of one or more other elements, unless the context clearly indicates otherwise.

The terms “about” and “substantially” are used herein in the sense of at, or nearly at, when given the manufacturing and material tolerances inherent in the stated circumstances and are used to prevent the unscrupulous infringer from unfairly taking advantage of the present disclosure where exact or absolute figures are stated as an aid to understanding the present disclosure.

“A and/or B” when used in this specification, specifies “either A or B or both.”

The present disclosure relates to a solid state battery comprising a solid electrolyte material as an electrolyte. Specific examples of the solid state battery include any type of primary battery, secondary battery, fuel cell, solar cell or capacitor, such as a super capacitor. In particular, the secondary battery is, to be specific, a lithium ion secondary battery.

In an embodiment, the solid state battery according to the present disclosure comprises a negative electrode, a positive electrode and a solid electrolyte layer interposed between the negative electrode and the positive electrode, and the negative electrode comprises a negative electrode active material layer including silicon (Si) as a negative electrode active material.

When lithium metal is used for the negative electrode, the energy density is high and life characteristics are long, but when the operating temperature is low, lithium dendrite growth is aggravated and battery performance degrades. However, the Si negative electrode has no risk of lithium dendrite growth and may exhibit good performance at room temperature, and thus is more advantageous than the lithium metal negative electrode. Meanwhile, in batteries using liquid electrolytes, the Si negative electrode exhibits high rate charging characteristics at low operating temperatures (for example, room temperature or less), while having low reversible areal capacities. In the case of liquid electrolyte batteries, it is not easy to introduce a high loading electrode. The battery according to the present disclosure can solve the above-described problem.

Hereinafter, the configuration and effect of the present disclosure will be described in detail.

In certain aspects, the silicon includes silicon particles. The silicon (Si) particles may have an average diameter (D50) of 0.1 μm to 10 μm, and preferably 3 μm to 5 μm. Within the above-described range of 0.1 μm to 10 μm, it is advantageous in terms of negative electrode manufacturing process and thickness uniformity of the negative electrode.

D50 means the median particle size or median particle diameter at 50% of the particle size distribution measured by particle size distribution. In this case, the particle diameter (D50) may mean a particle diameter measured before the electrode is manufactured. The average particle diameter (D50) may be measured using a laser diffraction method (e.g., a laser diffraction particle size measuring apparatus).

In an embodiment of the present disclosure, the negative electrode active material layer may include the silicon (Si) in an amount of 75 wt % or more, 76 wt % or more, 77 wt % or more, 78 wt % or more, 79 wt % or more, 80 wt % or more, 81 wt % or more, 82 wt % or more, 83 wt % or more, 84 wt % or more, 85 wt % or more, 86 wt % or more, 87 wt % or more, 88 wt % or more, 89 wt % or more, 90 wt % or more, 91 wt % or more, 92 wt % or more, 93 wt % or more, 94 wt % or more, 95 wt % or more, 96 wt % or more, 97 wt % or more, 98 wt % or more, 99 wt % or more or 99.9 wt % or more based on 100 wt % of the negative electrode active material layer. Meanwhile, in an embodiment of the present disclosure, it is possible to introduce the silicon (Si) having the purity of 97% or more as the negative electrode active material. When the purity of the silicon (Si) satisfies the above-described range, it may be advantageous in terms of initial irreversible reaction decrease and cell energy density improvement. Additionally, the negative electrode active material occupies most of the negative electrode composition in the negative electrode, so it is advantageous to obtain a homogeneous high loading electrode in terms of composition.

In a particular embodiment, after a charge/discharge cycle of the battery, the negative electrode active material layer forms a Li—Si alloy having at least one columnar structure. Preferably, the inorganic electrolyte does not permeate through the porous Si electrode prior to battery operation. In certain aspects, unlike conventional liquid electrolytes, it is possible to form an interface with the inorganic electrolyte, which is essentially limited to a two-dimensional (2D) plane. In this way, after lithiation of the Si, the 2D plane is retained, preventing the generation of new interfaces, e.g., preventing continuous SEI growth and trapped Li—Si accumulation, and/or mitigating growth of new interfaces, included by volume expansion that result in Li⁺ consumption.

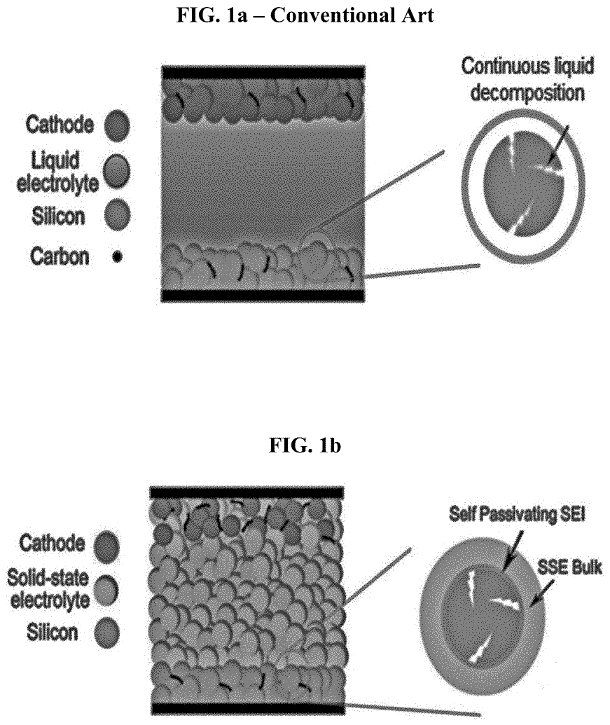

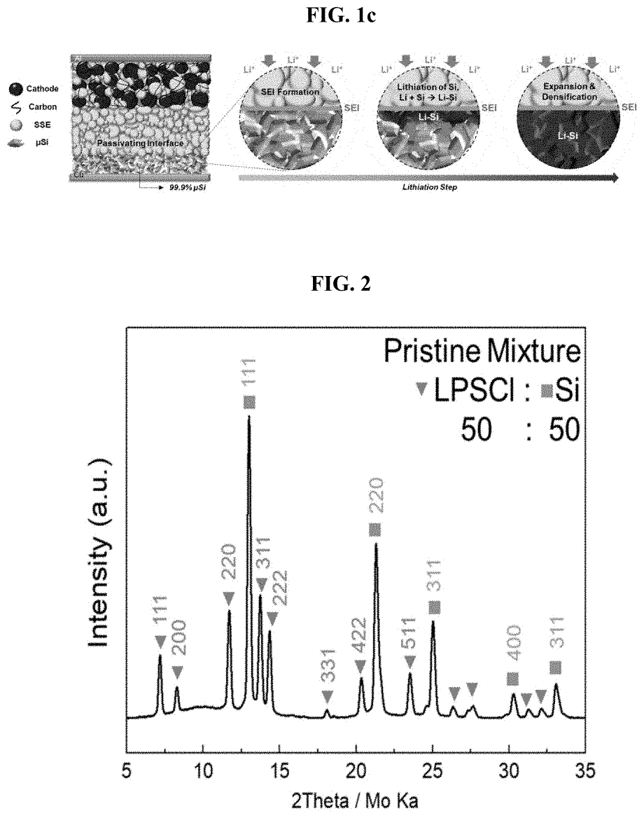

During operation of the battery, a passivating interface is formed and retained during battery operation, preventing the generation of new interfaces. During battery operation, as shown in FIG. 1c, the battery according to the present disclosure is characterized in that 1) a passivating electrolyte interface is formed between the negative electrode and the solid electrolyte layer during lithiation and silicon close to the interface are lithiated, 2) lithium ions diffuse from lithiated silicon to non-lithiated silicon, and 3) the reaction is performed over the negative electrode to form a Li—Si layer. Preferably, during the lithiation, a passivating electrolyte interface is formed between the Si and the inorganic electrolyte, followed by lithiation of the Si particles near the interface. The highly reactive Li—Si then reacts with the Si particles within its vicinity. The reaction propagates throughout the electrode, forming a densified Li—Si layer, as shown in FIG. 1c. In certain aspects, this process was found to be highly reversible, without the need for any excess lithium.

As shown in FIG. 1c, the Si particles are in direct ionic (Li⁺) and electronic (e⁻) contact with each other, which allows for fast diffusion of Li⁺ and transport of e⁻ throughout the electrode. If other insulative components are present, these may interfere with this process, and prevent the formation of the Li—Si alloy having a columnar structure. Therefore, the components of the electrode must be selected so that they do not interfere with the lithiation process, which forms the Li—Si alloy.

After lithiation reaction progresses, an Li—Si alloy forms a densified Li—Si layer. In some embodiments, the entire electrode forms an interconnected densified Li—Si layer. For instance, in the pristine state, the Si particles are discrete, but after formation of the Li—Si alloy having at least one columnar structure through the lithiation reaction, it is observed that most pores disappear between the pristine Si particles and the boundaries between separate Si particles may vanish. Even in the discharged state, it is observed that the Si particles do not revert back to their original discrete particle or microparticle structure, but instead form a Li—Si alloy with at least one columnar structure (e.g., large, connected structures of Li—Si alloy particles with one or more void(s) between them).

By “interconnected” is meant that some voids disappear and the Li—Si alloy particles appear to be connected. Any suitable method can be used, e.g., spectroscopy methods. By “densified” the density of the negative electrode material increases. Any suitable method can be used for measuring the density of the negative electrode material. For instance, in some aspects, a decrease in porosity shows that the negative electrode material is densified.

The term “columnar” structure refers to the morphology of the Li—Si alloy that forms, e.g., particles of Li—Si alloy may form interconnected particles. The columnar structure may extend from the current collector to the solid electrolyte layer or at least part of that distance. In some aspects, when an interfacial layer is present and in contact with the solid electrolyte, the columnar structure may extend from the current collector to the interfacial layer, or at least part of that distance. In some aspects, the “columnar” structure will begin to form after one or more charge/discharge cycle. Generally speaking, the term “columnar structure” may be understood as a structure wherein columns of material exist (e.g., Li—Si alloy) between two reference points, such as herein between the current collector and the solid electrolyte. The term “columnar structure” may be understood more broadly as Li—Si alloy material, for instance densely packed material including particles of Li—Si alloy, which form a generally columnar structure between the current collector and the solid electrolyte layer. This structure may include either or both of continuous and discontinuous structures formed from the Li—Si alloy. Such Li—Si alloy may exist as particles that are densely packed so as to appear to be monolithic in an aggregate nature. Included in such columnar structure are voids existing between locations of Li—Si alloy.

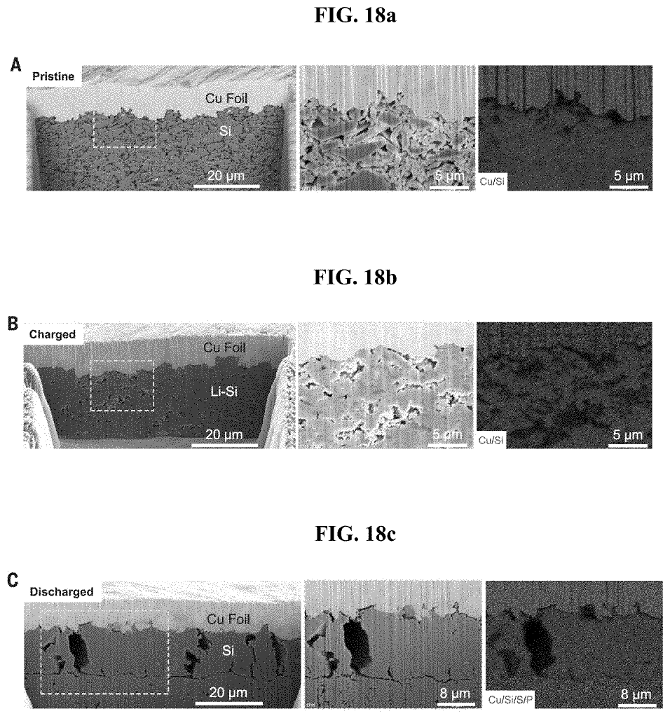

FIG. 18a to FIG. 18c, cross-section scanning electron microscopy (SEM) images of three separate μSi electrodes were prepared to visualize the morphological evolution of Li—Si, e.g., focused ion beam at the pristine, lithiated, and delithiated states. At the pristine state (FIG. 18a), discreet μSi particles (2 to 5 μm) were observed, with an electrode porosity of 40% after calendaring. After lithiation (FIG. 18b), the electrode becomes densified, with most pores disappearing between the pristine μSi particles. Moreover, the boundaries between separate μSi particles have entirely vanished. An enlarged view of the more porous region shows that the entire electrode has become an interconnected densified Li—Si alloy. After delithiation (FIG. 18c), the negative electrode active material layer forms a Li—Si alloy having at least one columnar structure with at least one void (e.g., between the columnar structure(s)). The μSi electrode did not revert back to its original discreet particle or microparticle structure but instead formed the columnar structure, e.g., large particles/structures with voids between them. It is noted that a lower loading was used to image the entire void's depth at the delithiated state. Energy-dispersive x-ray (EDS) imaging confirms that the pores are indeed voids, with no evidence of SEI or SSE present between each delithiated particle. The morphological behavior observed is in stark contrast to morphological changes of μSi particles in liquid electrolyte systems, where lithiated particles do not merge and remain separate as a result of SEI formed throughout the electrode.

In an embodiment, the negative electrode active material may contain at least 97 wt % silicon and 2 wt % carbon. In certain embodiments, in the Li—Si alloy having columnar particles and at least one void between the columnar particles, at least one void has a height that is 75-100% of the distance between the current collector of the negative electrode and the solid electrolyte layer. Preferably, at least one void has a height that is 85-100% of the distance between the current collector of the negative electrode and the solid electrolyte layer. More preferably, at least one void has a height that is 95-100% of the distance between the current collector of the negative electrode and the solid electrolyte layer.

In certain embodiments, in the Li—Si alloy having columnar particles and at least one void between the columnar particles, the voids have an average height that is 75-100% of the distance between the current collector of the negative electrode and the solid electrolyte layer. Preferably, the voids have an average height that is 85-100% of the distance between the current collector of the negative electrode and the solid electrolyte layer. More preferably, the voids have an average height that is 95-100% of the distance between the current collector of the negative electrode and the solid electrolyte layer.

In preferred aspects, other materials are not present or the negative electrode active material layer is substantially free of additional materials. For instance, bulk μSi exhibits an electronic conductivity of approximately 3×10⁻⁵ S cm⁻¹, comparable to most common cathode materials (˜10⁻⁶ to 10⁻⁴ S cm⁻¹), so additional carbon additives or other conductive materials are not necessary. In a particular embodiment of the present disclosure, it is preferred that the negative electrode active material layer has no conductive material, or is substantially free of conductive material. In particular, it is preferable to exclude the use of a carbon-based conductive material such as carbon black. In a particular embodiment of the present disclosure, it is preferred that the negative electrode active material layer has no binder, or is substantially free of binder.

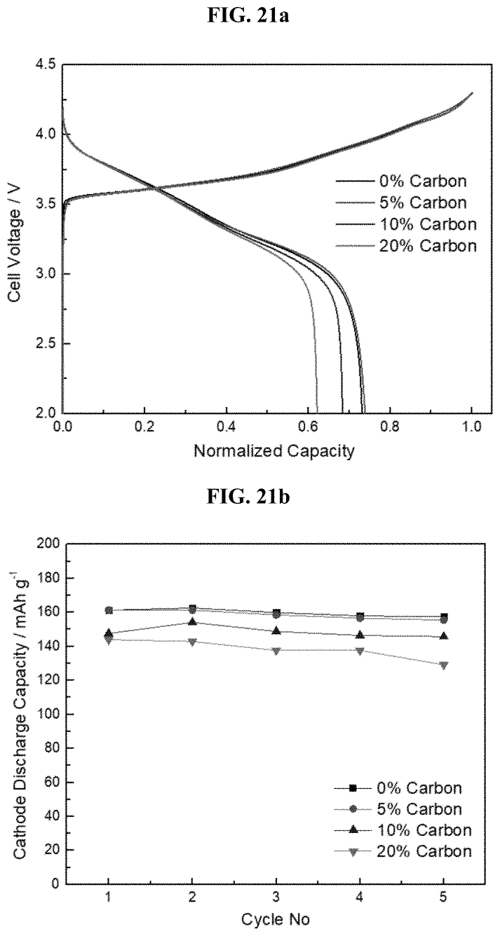

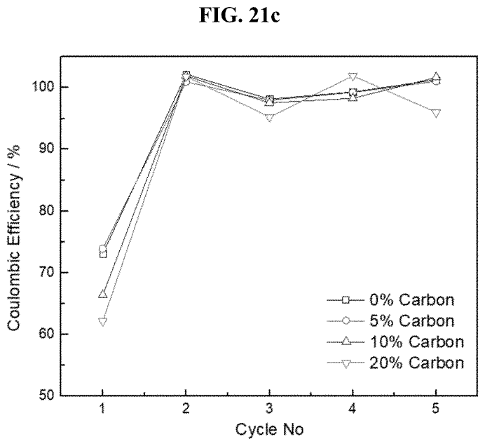

In a particular embodiment of the present disclosure, it is preferred that the negative electrode active material layer has no carbon, or is substantially free of carbon. While not wishing to be bound by theory, when the conductive material is included in the negative electrode active material layer, the irreversible decomposition reaction of the inorganic electrolyte is accelerated, which degrades the resistance characteristics and life performance of the battery. For instance, FIGS. 21a to 21c show the electrochemical data of carbon-containing silicon. As can be seen, increasing the amount of carbon may lower the first cycle Coulombic Efficiency (CE) and capacity utilization.

In certain aspects, the negative electrode active material layer is substantially free of conductive material.

In another aspects, the negative electrode active material layer is substantially free of binder.

In other aspects, the negative electrode active material layer is substantially free of solid state electrolyte.

By “essentially” not containing, or “substantially free” throughout the specification is meant that these components are not present in amounts equal to or less than 5 wt %, equal to or less than 4 wt %, equal to or less than 3 wt %, equal to or less than 2 wt %, equal to or less than 1 wt %, or equal to or less than 0.5 wt %. Preferably, these components are contained in amounts that do not interfere with the lithiation reaction described above. In some embodiments, the volume ratio of other components should be limited to amounts that do not interfere with the lithiation reaction to form the densified Li—Si alloy layer, or affect the formation of the columnar structure. For instance, the volume ratio of other components should be limited to equal to or less than 5 wt %, preferably equal to or less than 4 wt %, preferably equal to or less than 3 wt %, preferably equal to or less than 2 wt %, preferably equal to or less than 1 wt %. In particular, the amounts of other components should be limited to amounts that do not affect the formation of the columnar structure.

Additionally, it is preferred that the negative electrode active material layer according to the present disclosure comprises a smaller amount of solid electrolyte, preferably no solid electrolyte. Since the negative electrode active material layer of the present disclosure has a high amount of silicon (Si) and volume changes during charging/discharging, in terms of interfacial contact maintenance, the negative electrode active material layer comprises a small amount of solid electrolyte, and preferably no solid electrolyte.

In an embodiment of the present disclosure, the negative electrode active material layer may include Si alone or Si in combination with a binder resin, and in this instance, the binder resin may be included in an amount of equal to or less than 10 wt %, equal to or less than 1 wt %, or equal to or less than 0.1 wt % based on 100 wt % of the negative electrode active material layer.

The negative electrode may comprise a negative electrode current collector, and in this instance, the negative electrode active material layer may be formed on at least one surface of the current collector. In an embodiment of the present disclosure, the thickness of the negative electrode active material layer may range from about 10 μm to 100 μm, and for example, may be formed with the thickness of 10 μm to 70 μm or 10 μm to 50 μm.

In an embodiment of the present disclosure, the porosity of the negative electrode active material layer before initial charge/discharge cycles may be 25 vol % to 65 vol %, and preferably 25 vol % to 40 vol %. Meanwhile, the negative electrode active material layer may be 10 μm to 50 μm thick.

The pores refer to interstitial volume formed by spaces between silicon (Si) particles, and the negative electrode active material layer has a porous structure resulting from the interstitial volume.

The porous structure of the negative electrode active material layer has an important technical significance in reducing the volume expansion of the negative electrode according to the present disclosure.

The negative electrode active material layer forms a Li—Si alloy phase and has volume expansion during charging, and expands the volume into its own pores, so the porosity may significantly reduce during charging. In an embodiment of the present disclosure, the negative electrode active material layer may have the porosity of 10 vol % or less in the range of SOC 90% to SOC 100%.

The pore size or distribution may be different from those before the initial cycle, but the volume occupied by the pores may be equally maintained.

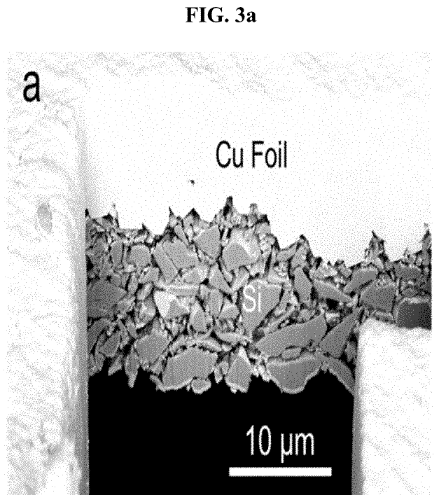

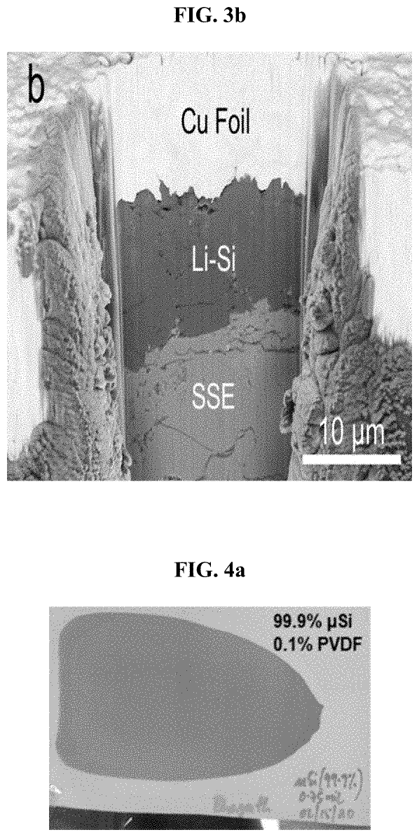

Hereinafter, FIGS. 3a and 3b show the state of the negative electrode before charge/discharge cycles (3a) and after charge/discharge cycles (3b) in the negative electrode according to the present disclosure. Referring to FIG. 3a, before charge/discharge cycles, the negative electrode exhibits the porous properties due to the pores between each particle. The pore size is dependent on the particle size of the negative electrode active material, and according to the drawing, the pore size is found to be about 3 μm to about 5 μm. When the negative electrode is lithiated during charge/discharge cycles, the volume expands to the pores, the pore volume reduces, and it returns to silicon metal lithiated at high density (FIG. 3b). The negative electrode has the limited expansion to a direction (Z-axis direction) perpendicular to the thickness wise direction of the negative electrode. This prevents excessive stress from being applied to the inorganic or solid electrolyte layer and may prevent cracking-induced battery performance degradation.

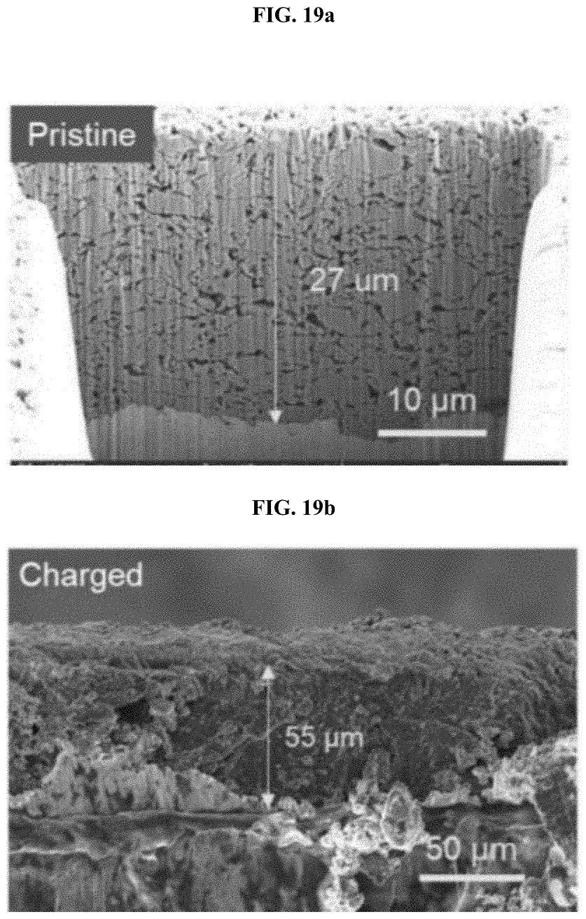

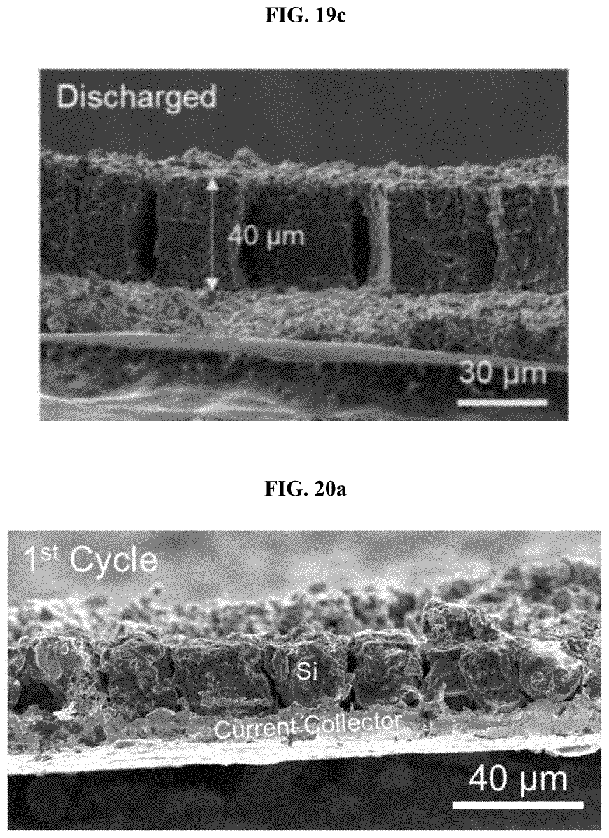

To quantify thickness growth and porosity changes during cycling, μSi electrodes with similar mass loadings of ˜3.8 mg cm⁻² were prepared and measured for thicknesses during charge and discharge states. At the pristine state, a thickness of ˜27 mm was measured (FIG. 19a), and after lithiation to Li_{3.35}Si, the thickness increased to ˜55 mm (FIG. 19b). This increase falls short of the expected >300% growth, indicating that a substantial decrease in initial 40% porosity must occur. The table below shows the expected electrode layer thickness vs relative density at the pristine, charged and discharged states. Thick electrodes of ˜3.8 mg cm⁻²Si were used in the calculations to reduce measurement error.

Asterisks* indicate approximate observed thicknesses measured with SEM imaging:

| Density | 100% | 90% | 80% | 70% | 60% | 50% | mAh/cm² | mAh/g⁻¹ |
|---|---|---|---|---|---|---|---|---|
| Pristine/μm | 16.3 | 18.1 | 20.4 | 23.3 | 27.2* | 32.6 | — | — |
| Charged/μm | 52.2 | 58.0* | 65.3 | 74.6 | 87.0 | 104.4 | 12.2 | 3210 |
| Discharged/μm | 29.4 | 32.6 | 36.7 | 41.9* | 48.9 | 58.7 | 3.05 | 803 |

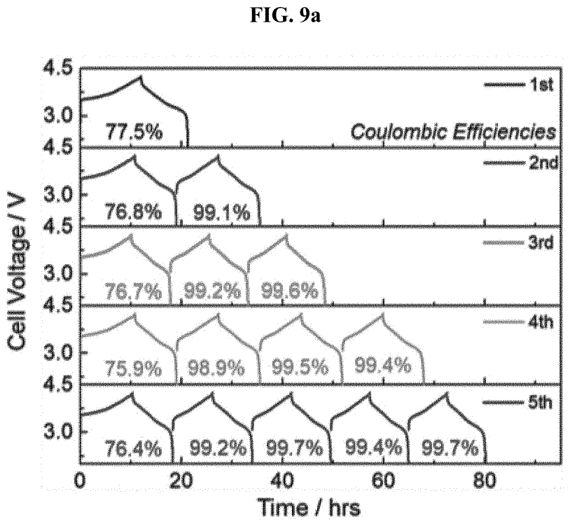

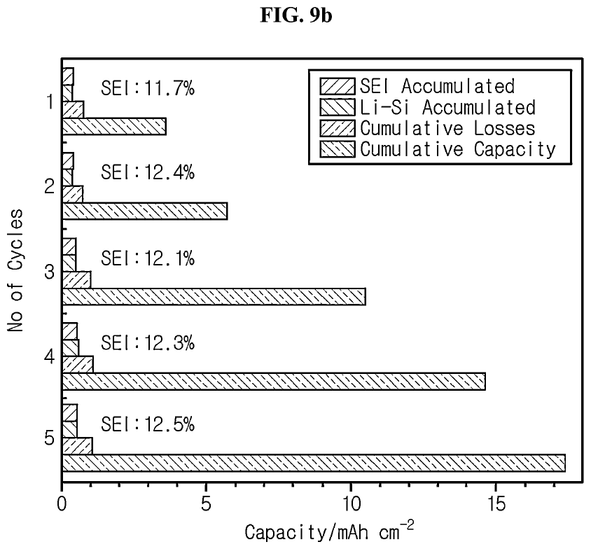

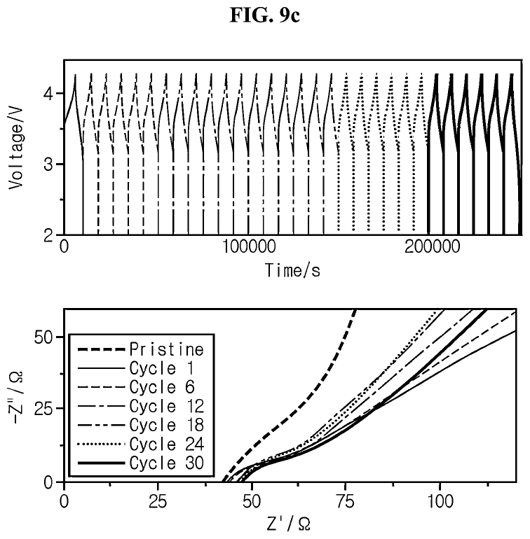

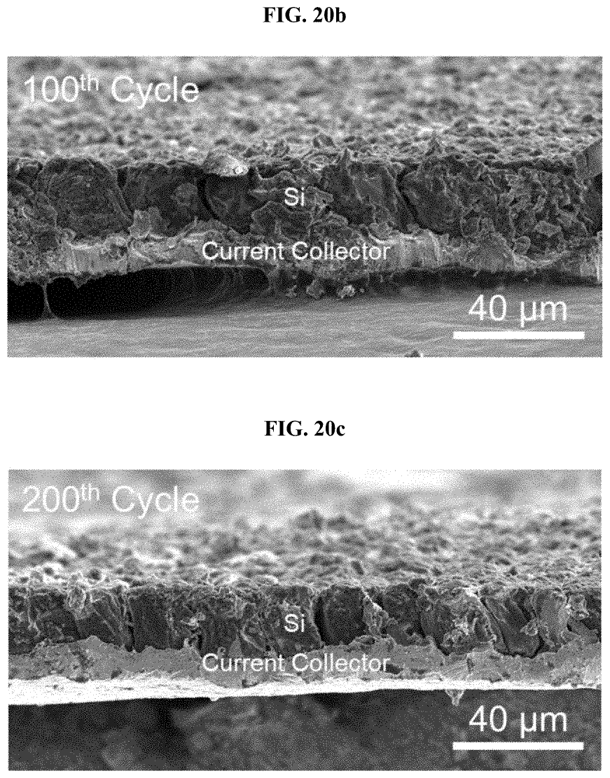

The table above shows a low resulting porosity (<10%) of the ˜55-mm mSi electrode after lithiation. This agrees with the qualitative observations made in FIG. 18a-18c, where considerable densification is observed compared to the pristine state. After delithiation (FIG. 19c), a thickness of ˜40 mm was measured, with a porosity of ˜30% calculated. The lower porosity at the delithiated state compared to the pristine 40% is expected, as some Li+ remains in the anode (FIG. 9b). Despite the relatively large thickness and porosity changes, similar morphologies and thicknesses were observed after multiple cycles (FIG. 20a-20c). This suggests that the mechanical properties of the Li—Si and inorganic electrolyte have a crucial role in maintaining the integrity of the interfaces as well as retaining contact with the anode along the 2D interfacial plane.

Although contact losses are less likely during lithiation, where volume expansion occurs, it is an important consideration during delithiation. Preferably, good contact is maintained between the inorganic electrolyte layer and the porous structure of the delithiated Li—Si (FIG. 18c). This indicates that some degree of Li—Si deformation occurred during cell cycling under a uniaxial applied stack pressure of 50 MPa with a home-made pressure rig. Although pristine μSi did not deform under calendering pressures of 370 MPa, existing reports found that hardness of Li—Si alloys decreases substantially as a function of lithiation, with values reaching as high as 10.0 to 11.6 GPa for pristine Si, to as low as 1.3 to 1.5 GPa for fully lithiated Li_{3.75}Si. It has been observed that lithiated Li—Si with lower hardness could undergo sufficient deformation to form a dense alloy with low porosity (FIG. 18b), whereas delithiated Li—Si with higher hardness could not be fully deformed, evident from the large interparticle voids observed (FIG. 18c). Although the stack pressure of 50 MPa applied in this study is lower than the range of Li—Si hardness values reported in the literature, absolute conclusions on its deformability cannot be drawn from the hardness values alone. As an example, sulfide glasses, such as Li₂S—P₂S₅, were previously found to exhibit a hardness value of 1.9 GPa, yet they can be readily deformed at compaction pressures of 360 MPa. Likewise, crystalline Li₆PS₅Cl, which is expected to exhibit higher hardness than glassy Li₂S—P₂S₅, can also be deformed into a pellet for cell cycling at 50 MPa. Additionally, most mechanical studies conducted on Li—Si alloys have so far been limited to nano-indentation-based experiments on Si thin films, which can exhibit appreciably different mechanical properties compared with the μSi used in this work. As such, it is plausible for the lithiated μSi to undergo some degree of plastic deformation, especially at higher states of lithiation. To verify this, a 99.9 wt % μSi electrode was lithiated up to 0.01 V versus Li/Li+ without pressure in a liquid electrolyte-based coin cell. Subsequently, this Li—Si electrode was imaged before and after pressing at 50 MPa. Some degree of deformation was observed, e.g., the lithiated Li—Si alloy was induced, along with a reduction in electrode porosity. In one aspect, this deformation is helpful to maintain a good contact with the solid electrolyte layer, enabling high reversibility.

In an embodiment of the present disclosure, the negative electrode active material layer may be manufactured, for example, by the following method.

In an embodiment of the present disclosure, the negative electrode active material layer may be obtained by adding silicon powder to a solvent and dispersing to prepare a slurry, applying the slurry to an appropriate negative electrode current collector and drying. Meanwhile, a predetermined pressure of, for example, about 370 MPa may be applied to adjust the thickness and porosity of the dried result. The porosity may be appropriately adjusted to the above-described level. The solvent may further comprise a binder resin and the amount of the binder resin may be adjusted to an amount of equal to or less than 10 wt %, equal to or less than 1 wt %, or equal to or less than 0.1 wt % based on 100 wt % of the finally obtained negative electrode active material layer. The method of applying the pressure is not limited to a particular one, and well-known methods of applying the pressure may be selectively applied.

The solvent may include, for example, N-methyl-2-pyrrolidone (NMP), but is not particularly limited thereto, and may include any solvent that does not affect the electrical and chemical properties of silicon (Si). In certain preferred embodiments, when using PVdF binder, it is preferable to use NMP, and when using other binder types such as SBR-CMC, Li-PAA, water-based (H₂O) solvent can preferably be used. In addition, if PEO and lithium salts (e.g., LiTFSI) are used as binders and additives, any suitable solvent may be used, including acetonitrile, etc.

Specifically, the negative electrode may be manufactured by the following method. Silicon (Si) powder is dispersed in NMP comprising 0.1 wt % poly(vinylidene difluoride), the dispersion is mixed using a mixer until a slurry is formed and the slurry is applied to the current collector. The result is dried under vacuum at 80° C. For example, the target porosity of the negative electrode may be set to about 33%.

The solid state battery according to the invention may preferably have a negative electrode, a positive electrode and a solid electrolyte interposed between the negative electrode and the positive electrode. The solid electrolyte can be an inorganic-based electrolyte or an organic-based electrolyte. In certain aspects, the solid electrolyte may preferably be selected from a sulfide-based solid electrolyte, an oxide-based solid electrolyte, a halide-based solid electrolyte, or a hydride-based solid electrolyte. In certain aspects, the organic-based electrolyte may be selected from a polymer-based electrolyte or a gel electrolyte.

Examples of an oxide-based solid electrolyte include but are not limited to lithium lanthanum zirconium oxide (LLZO, Li₇La₃Zr₂O₁₂), Lithium Aluminum Titanium Phosphate (LATP, Li_{1.4}Al_{0.4}Ti_{1.6}(PO₄)₃), Lithium Aluminum Germanium Phosphate (LATP, Li_{1.5}A_{10.5}Ge_{1.5}(PO₄)₃).

Examples of a halide-based solid electrolyte include but are not limited to lithium zirconium oxide (LZC, Li₂ZrC₁₆), lithium yitrium oxide (LYC, Li₃YC₁₆), and lithium indium oxide (LIC, Li₃InCl₆).

Examples of a hydride-based solid electrolyte include but are not limited to methylamine lithium borohydride (LiBH₄.CH₃NH₂), Lithium borohydride-Lithium halide (LiBH₄LiI/LiBr/LiCl), and lithium carboborates (LiCB₁₁H₁₂).

In certain aspects, the solid electrolyte layer comprises a solid electrolyte, and the solid electrolyte may comprise a sulfide-based solid electrolyte. The sulfide-based solid electrolyte may contain sulfur (S) and have the ionic conductivity of metal belonging to Group I or II in the periodic table, and may comprise Li—P—S-based glass, Li—P—S-based glass ceramic and argyrodite-based sulfide-based solid electrolyte. Non-limiting examples of the sulfide-based solid electrolyte may include at least one of xLi₂S-yP₂S₅, Li₂S—LiI—P₂S₅, Li₂S—LiI—Li₂O—P₂S₅, Li₂S—LiBr—P₂S₅, Li₂S—Li₂O—P₂S₅, Li₂S—Li₃PO₄—P₂S₅, Li₂S—P₂S₅—P₂O₅, Li₂S—P₂S₅—SiS₂, Li₂S—P₂S₅—SnS, Li₂S—P₂S₅—Al₂S₃, Li₂S—GeS₂ or Li₂S—GeS₂—ZnS, Li₆PS₅X (X=at least one of Cl, Br or I). In an embodiment of the present disclosure, the sulfide-based solid electrolyte may comprise at least one selected from LPS-based glass or glass ceramic such as xLi₂S-yP₂S₅, or an argyrodite-based sulfide-based solid electrolyte (Li₆PS₅X; X=Cl, Br, I, for instance, Li₆PS₅Cl, supplied by NEI Corporation).

In the present disclosure, the average particle size of the sulfide-based solid electrolyte may be adjusted to an appropriate range for the solid state battery. In a particular embodiment of the present disclosure, the solid electrolyte may have an average particle size (D50) of 0.1 μm to 50 μm. Additionally, in an embodiment of the present disclosure, the selected solid electrolyte has the ionic conductivity of 1×10⁻⁵ S/cm, preferably 1×10⁻³ S/cm or more.

In an embodiment of the present disclosure, the solid electrolyte layer may be manufactured, for example, by the following method.

First, a solid electrolyte material is prepared. The solid electrolyte material may be prepared by obtaining from commercially available products or manufacturing by the following method. The solid electrolyte material may be manufactured by the following method. First, LiCl, Li₂S and P₂S₅ are mixed in stoichiometric amounts, and milled by a planetary ball milling method to obtain a homogenous mixture. The mixture may be thermally treated at high temperature for a predetermined time to obtain the intended Li₆PS₅Cl solid electrolyte. The thermal treatment may be performed at about 550° C. and the thermal treatment time may be about 8 hours.

Subsequently, the solid electrolyte material is added to a predetermined organic solvent and dispersed to prepare a slurry, the slurry is applied to a release plate and dried to form a sheet shape. If necessary, the result of the sheet shape may be pressed to obtain a solid electrolyte layer.

In an embodiment of the present disclosure, the positive electrode may comprise a positive electrode active material layer comprising a positive electrode active material, a positive electrode conductive material and a solid electrolyte. The positive electrode active material layer may further comprise a binder resin for the positive electrode, if necessary. Additionally, the positive electrode comprises a current collector, if necessary, and the positive electrode active material layer may be positioned on at least one surface of the current collector.

In an embodiment of the present disclosure, the positive electrode active material may comprise at least one of lithium cobalt oxide (LiCoO₂), lithium nickel oxide (LiNiO₂), lithium manganese oxide of Formula Li₁₊ₓMn₂₋ₓO₄ (x is 0 to 0.33, for example LiMn₂O₄), LiMnO₃, LiMn₂O₃, LiMnO₂, lithium copper oxide (Li₂CuO₂); vanadium oxide such as LiV₃O₈, LiV₂O₄, V₂O₅, Cu₂V₂O₇, Ni-site lithium nickel oxide represented by Formula LiNi₁₋ₓMₓO₂ (M=Co, Mn, Al, Cu, Fe, Mg, B or Ga, 0<x<1), for example, LiNi_{1-z}(Co,Mn,Al)_{z}O₂ (0<z<1); lithium manganese composite oxide represented by Formula LiMn₂₋ₓMₓO₄ (M=Co, Ni, Fe, Cr, Zn or Ta, x=0.01˜1, for example, LiMn_{1.5}Ni_{0.5}O₄ or Li₂Mn₃MO₈ (M=Fe, Co, Ni, Cu or Zn); LiMn₂O₄ with partial substitution of alkali earth metal ion for Li in Formula; disulfide compounds; Fe₂(MoO₄)₃, or lithium iron phosphate (LiFePO₄). In an embodiment of the present disclosure, the lithium iron phosphate may have all or at least part of the of the active material particle surface coated with a carbon material to improve conductivity.

Preferably, the positive electrode active material may comprise at least one selected from Lithium Nickel Cobalt Manganese Oxide (for example, Li(Ni,Co,Mn)O₂, LiNi_{1-z}(Co,Mn,Al)_{z}O₂ (0<z<1)), Lithium Iron Phosphate (for example, LiFePO4/C), Lithium Nickel Manganese Spinel (for example, LiNi_{0.5}Mn_{1.5}O₄), Lithium Nickel Cobalt Aluminum Oxide (for example, Li(Ni,Co,Al)O₂), Lithium Manganese Oxide (for example, LiMn₂O₄) and Lithium Cobalt Oxide (for example, LiCoO₂).

In the present disclosure, most preferably the positive electrode active material may comprise lithium transition metal composite oxide, and the transition metal may comprise at least one of Co, Mn Ni or Al.

In an embodiment of the present disclosure, the lithium transition metal composite oxide may comprise at least one of compounds represented by the following formula 1.

LiₓNiₐCo_{b}Mn_{c}M_{z}O_{y} [Formula 1]

In the above Formula 1, 0.5≤x≤1.5, 0<a≤1, 0≤b<1, 0≤c<1, 0≤z<1, 1.5<y<5, a+b+c+z is 1 or less, and M may comprise at least one selected from Al, Cu, Fe, Mg and B.

In an embodiment of the present disclosure, the positive electrode active material preferably includes a positive electrode active material having high Ni content of “a” of 0.5 or more and equal to or less than 1, and its specific example may comprise LiNi_{0.8}Co_{0.1}Mn_{0.1}O₂.

In a particular embodiment of the present disclosure, the positive electrode conductive material may be, for example, at least one conductive material selected from the group consisting of graphite, carbon black, carbon fibers or metal fibers, metal powder, conductive whiskers, conductive metal oxide, activated carbon or polyphenylene derivatives. More specifically, the positive electrode conductive material may be at least one conductive material selected from the group consisting of natural graphite, artificial graphite, super-p, acetylene black, ketjen black, channel black, furnace black, lamp black, thermal black, denka black, aluminum powder, nickel powder, zinc oxide, potassium titanate and titanium oxide.

The current collector is not limited to a particular type and may include those having high conductivity without causing a chemical change in the corresponding battery, for example, stainless steel, copper, aluminum, nickel, titanium, sintered carbon, or aluminum or stainless steel treated with carbon, nickel, titanium and silver on the surface.

The positive electrode binder resin may include polymer for electrode commonly used in the technical field. Non-limiting examples of the binder resin may include, but are not limited to, polyvinylidene difluoride, polyvinylidene fluoride-co-hexafluoropropylene, polyvinylidene fluoride-co-trichloroethylene, polymethylmethacrylate, polyethylhexyl acrylate, polybutylacrylate, polyacrylonitrile, polyvinylpyrrolidone, polyvinylacetate, polyethylene-co-vinyl acetate, polyethylene oxide, polyarylate, cellulose acetate, cellulose acetate butyrate, cellulose acetate propionate, cyanoethylpullulan, cyanoethylpolyvinylalcohol, cyanoethylcellulose, cyanoethylsucrose, pullulan and carboxyl methyl cellulose.

In an embodiment of the present disclosure, the solid electrolyte included in the positive electrode may comprise at least one selected from a polymer-based solid electrolyte, an oxide-based solid electrolyte, a sulfide-based solid electrolyte, a halide-based solid electrolyte, and a hydride-based solid electrolyte. In an embodiment of the present disclosure, preferably the positive electrode active material may comprise the sulfide-based solid electrolyte described in the solid electrolyte layer.

In an embodiment of the present disclosure, the positive electrode active material is preferably included in the positive electrode in an amount of 70 wt % or more based on 100 wt % of the positive electrode active material layer. Additionally, the solid electrolyte is preferably included in the positive electrode in an amount of 10 wt % to 30 wt % based on 100 wt % of the positive electrode active material layer.

Meanwhile, in a particular embodiment of the present disclosure, the positive electrode may have a loading amount (per electrode area) of 5 mAh/cm² or more, 6 mAh/cm² or more, or 10 mAh/cm² or more. In the battery according to the present disclosure, when the high loading positive electrode is applied, it is possible to operate the battery on the electrochemically stable level.

Meanwhile, in a particular embodiment of the present disclosure, the positive electrode active material layer may be obtained by adding the positive electrode active material, the conductive material, the binder resin and the solid electrolyte to an appropriate solvent to prepare a slurry and casting the slurry, or may be obtained by a manufacturing method according to a dry mixing process without a solvent. Meanwhile, in an embodiment of the present disclosure, it is possible to achieve the uniform mixing of the positive electrode materials in the positive electrode, thereby obtaining a high loading positive electrode, and in this aspect, the positive electrode is preferably obtained by the dry mixing process using no solvent.

The method of manufacturing the positive electrode active material layer by the dry mixing method may be described, for example, as below. First, the positive electrode materials comprising the positive electrode active material, the conductive material and the binder resin are put into a mixing device and mixed by a mechanical method to obtain a mixture. The mixing device includes any type of device that can form a comparatively homogeneous mixture phase such as a well-known mixer agitator, and is not limited to a particular type of device. Meanwhile, in an embodiment of the present disclosure, to improve the dispersion of solids and induce the fibrous form of the binder resin in the mixing process, a temperature rising process may be included. In the temperature rising process, the temperature may be appropriately controlled in the range of about 30° C. to 100° C.

Subsequently, the positive electrode active material layer may be formed by extracting the mixture into the shape of an electrode (a wide film shape) using an extruder, and adjusting the thickness through a pressing process. The positive electrode active material layer may be applied to the electrode with no current collector, or if necessary, the current collector may be attached to the obtained positive electrode active material layer to the positive electrode including the current collector.

The positive electrode active material may include, for example, commercially available NCM811 (supplied by LG Chem, LiNi_{0.8}Co_{0.1}Mn_{0.1}O₂) positive electrode material. Meanwhile, if necessary, all or at least part of the particle surface of the positive electrode material may be coated with boron or niobium-based protective coating layers. The coating may use a dry method or a sol-gel method, but is not particularly limited to any one method. A positive electrode composition comprising the positive electrode active material, the conductive material, the solid electrolyte and the binder resin as prepared is manufactured, placed in a mold and pressed to form into a sheet shape. When the positive electrode is manufactured by the dry method, it is possible to achieve a more homogeneous mixture phase of the positive electrode components, and give uniform electrical and chemical properties all over the positive electrode.

Meanwhile, in an embodiment of the present disclosure, the solid state battery according to the present disclosure may be manufactured, for example, by the following method. As described above, the negative electrode, the solid electrolyte layer and the positive electrode are prepared, stacked in that order, and subjected to pressure to obtain a battery. In this instance, for example, metallic plungers enclosed in a polyetheretherketone (PEEK) die or any other insulative holder may be used.

Meanwhile, in a particular embodiment of the present disclosure, the solid state battery according to the present disclosure may have the NP ratio ranging from 0.1 to 30. Within the above-described range of NP ratio, stable and constant electrical and chemical properties are provided. The NP ratio may range, for example, from 0.5 to 10, from 0.8 to 10, from 1.0 to 10, or from 1.0 to 5, and the NP ratio ranging from 1.0 to 1.5 is advantageous in terms of battery energy density.

The solid state battery according to an aspect of the present disclosure does not comprise a carbon material solid electrolyte such as a conductive material in the negative electrode active material layer and comprises the controlled minimum amount of binder, and thus comprises the increased amount of the negative electrode active material silicon (Si) in the negative electrode active material layer, resulting in improved energy density.

The solid state battery according to the present disclosure forms a strong passivation solid electrolyte interphase (SEI) at the initial charge/discharge cycle to physically block any unreacted solid electrolyte and the silicon surface when a new surface is formed by fracture in silicon due to the charge/discharge and volume changes. This strong SEI results in the benefits of avoiding electrolyte decomposition, and eliminates or controls the use of conductive material, solid electrolyte and binder in the negative electrode active material layer to a predetermined level, resulting in the increased amount of the negative electrode active material silicon (Si) in the negative electrode. As a result, the solid state battery according to the present disclosure can solve the capacity degradation and cycle life reduction problems occurring in the conventional liquid electrolyte battery.

FIG. 1a is a diagram showing the conventional liquid electrolyte system and FIG. 1b is a diagram showing the electrolyte system of the present disclosure. The conventional liquid electrolyte battery has continuous SEI formation due to the decomposition of the electrolyte solution at a new interface, leading to capacity loss. However, the battery system of the present disclosure uses the solid electrolyte, thereby preventing the electrolyte decomposition as in the liquid electrolyte.

Meanwhile, FIG. 1c details the lithiation mechanism of the negative electrode in the solid state battery of the present disclosure. According to FIG. 1c, the battery according to the present disclosure is characterized in that 1) passivating SEI is formed between the negative electrode and the solid electrolyte layer during lithiation and silicon close to the interface are lithiated, 2) lithium ions diffuse from lithiated silicon to non-lithiated silicon, and 3) the reaction is performed over the negative electrode to form a Li—Si layer.

Additionally, the solid state battery according to the present disclosure ensures heat resistant stability compared to the conventional lithium ion battery (LIB) using liquid electrolyte. Meanwhile, the solid state battery according to the present disclosure comprises a bulk type of negative electrode having silicon content as described above and has much higher battery capacity than a thin film type of negative electrode synthesized by a sputtering or vapor deposition method. Additionally, as described above, the negative electrode may be manufactured by a straightforward method, so it is possible to provide a high cost saving effect and achieve the mass production level of processability.

One or more advantages of the solid state battery according to the present disclosure will be described in detail as below.

High silicon composition fraction: Conventional silicon negative electrodes in liquid electrolyte batteries often include silicon nano or micro particles, carbon additives and polymeric binders, with most reporting a silicon weight ratio of about 50%, few reports can exceed 70% weight fraction and even so, achieves more than 100 cycles of cell performance in the full cell. The solid state battery according to one aspect of the present disclosure may achieve more than 99.9% of silicon weight fraction in the negative electrode, eliminating or minimizing the use of carbo-based conductive material, solid electrolyte and binder resin. This electrode can cycle more than 100 cycles in a full cell with low NP ratio and with more than 90% capacity retention. To achieve more than 99.9 wt % of silicon weight fraction in the negative electrode and control the loading amount for matching of the intended NP ratio, it is preferable to use silicon particles of micron level and it is necessary to disperse them in an organic solvent together with minor binder components. For example, the binder components may be present in negative electrode in an amount of equal to or less than 0.1%. Meanwhile, even with almost no binder component, the silicon negative electrode remains in good contact with the current collector and can be applied to the solid state battery. Meanwhile, to reduce the porosity of the negative electrode and achieve high electrode packing density, the negative electrode may be calendered to at least 370 MPa before integration into the battery. As silicon expansion occurs up to 300%, the ideal porosity of the negative electrode is about 33% to minimize the volume change of the battery during charge/discharge. In the battery according to the present disclosure, since the negative electrode has the above-described porosity range, when volume expansion of the negative electrode occurs during the charge/discharge of the battery, the negative electrode would expand into its own pores, avoiding mechanical fracture at the interface between the solid electrolyte and the negative electrode.

Interface stabilization: The primary source for battery performance degradation in conventional liquid electrolyte batteries using silicon negative electrode is continuous SEI formation as a result of reduction of the electrolyte solution during exposure to fresh surfaces during cycling. One aspect of present disclosure directly addresses this problem by using a solid electrolyte, for instance, a sulfide-based solid electrolyte, that exhibits passivating SEI nature, preventing continuous electrolyte decomposition and SEI formation after the first cycle. This prevents loss of active material, retaining battery capacity and also reduces impedance growth over time. As not all sulfide-based solid electrolytes are compatible with silicon negative electrodes, careful selection of the sulfide-based solid electrolyte material should be done in order to ensure passivating nature of its SEI. This is done by studying the electrochemical stability window of a range of sulfide-based solid electrolytes and identifying their reduction product species. In general, there are two types of interfaces between solid electrolytes and silicon negative electrode: ionically conductive and mixed conductive ones. The ionically conductive interfaces only comprise ionically conductive products and insulators. The mixed conductive interfaces comprise ionically conductive and electrically conductive products. A passivating interface should be one formed from a solid electrolyte that forms only ionically conductive interfaces with no electrically conductive component.

High energy and power density: Conventional silicon secondary batteries using liquid electrolytes are unable to achieve high energy due to excessive inactive materials in the electrode. Due to the absence of excessive inactive materials in the negative electrode, the secondary battery according to the present disclosure achieves high packing density of silicon, allowing low porosity and electrodes with low thickness to enable high power density due to its low resistance. The negative electrode according to the present disclosure allows for high specific capacity and high energy density per volume due to lower battery volume compared with the negative electrode of the conventional liquid electrolyte battery. Due to the alloying mechanism of silicon with lithium ions, compared with plating or intercalation mechanism in conventional lithium metal or carbon-based negative electrodes, the present disclosure greatly reduces the risks of lithium dendrite growth. Compared with low alloy overpotential of thin and dense electrodes, the solid state battery of the present disclosure may have high rate capability and power density. When compared with a thin solid electrolyte layer and high loading transition metal oxide positive electrodes, lower N/P ratios can be used to reduce the excess mass in the batteries, increasing overall energy density. Additionally, the present disclosure adopts large stacking formats, reducing the dead weight of inactive components such as packing, and liquid electrolyte excess, further increasing the specific and volumetric energy density.

Hereinafter, the present disclosure will be described in more detail through examples, but the following examples are intended to describe the present disclosure for illustrative purposes, and the scope of the present disclosure is not limited thereto. The examples of the present disclosure are provided to describe the present disclosure to those skilled in the art fully and completely. Furthermore, Darren H. S. Tan, et al., “Carbon-free high-loading silicon anodes enabled by sulfide solid electrolytes,” Science, Vol 373, Issue 6562, pp. 1494-1499 (Sep. 24, 2021), as well as the supplemental materials thereof (https://science.org/doi/10.1126/science.abg7217) are hereby expressly incorporated by reference in its entirety.

### EXAMPLE

Since a sulfide-based material is sensitive to air and humidity, it decomposes to produce toxic gas such as H₂S, so all the synthesis and test steps are performed in a glove box (Mbraun MB 200B, H₂O<0.5 ppm, O₂<5.0 ppm) filled with argon.

1. Manufacture of battery

### Example 1-1

1) Manufacture of Negative Electrode

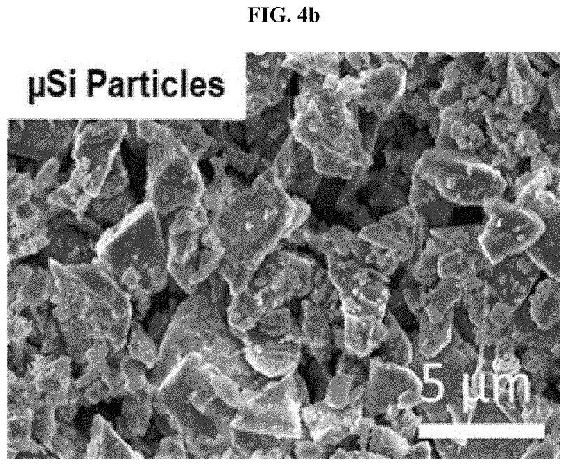

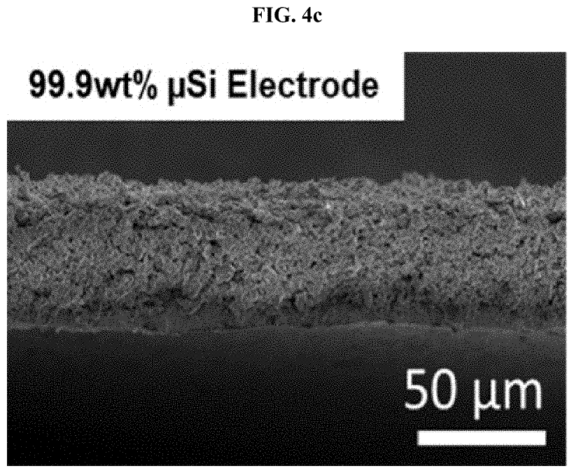

Si powder (Alfa Aesar, particle size 3 μm to 5 μm) is added to a solution of 0.1 wt % of PVDF (Kynar (HSV-900)) in N-Methyl-2-Pyrrolidone and mixed to prepare a negative electrode forming slurry. The concentration of the slurry is about 25 wt %, and a weight ratio of the Si powder and the PVDF is 99.9:0.1. The slurry is applied to a copper thin film (10 μm thick) using a doctor blade. This is dried overnight under vacuum at 80° C. to remove the solvent, and cut into a disc shape to obtain a negative electrode. The obtained negative electrode has a thickness of 45 μm and a loading amount of 13.2 mAh/cm². Additionally, digital images and scanning electron microscope (SEM) images of the obtained negative electrode are shown in FIGS. 4a to 4c. FIG. 4a is a digital image, and FIGS. 4b and 4c are SEM images.

2) Manufacture of Positive Electrode

NCM811 (LG Chem, LiNi_{0.8}Co_{0.1}Mn_{0.1}O₂), Li₆PS₅Cl (NEI Corporation), VGCF (Sigma Aldrich (Graphitized, Iron-free)) and Polytetrafluoroethylene (PTFE, Dupont) are mixed at a weight ratio of (78:19.5:2:0.5) and dry mixed in a heated mortar, followed by hot rolling using a stainless steel cylinder to adjust the thickness. This is cut into a proper shape to obtain a positive electrode. The obtained positive electrode has a thickness of 240 μm and a loading amount of 12.0 mAh/cm².

Meanwhile, the NCM811 has boron coating on the surface. Additionally, the Li₆PS₅Cl is prepared by pre-milling in a 45 ml ZrO₂ ball mill jar (Emax, Retsch). The jar is filled with argon gas, and a wet milling method using anhydrous xylene as a dispersion medium is applied. The milling is performed at the rate of about 300 rpm at room temperature for 2 hours. Subsequently, the Li₆PS₅Cl is taken out of the jar and dried overnight under vacuum at 80° C., and the dried result is fed into the dry manufacturing process of the positive electrode.

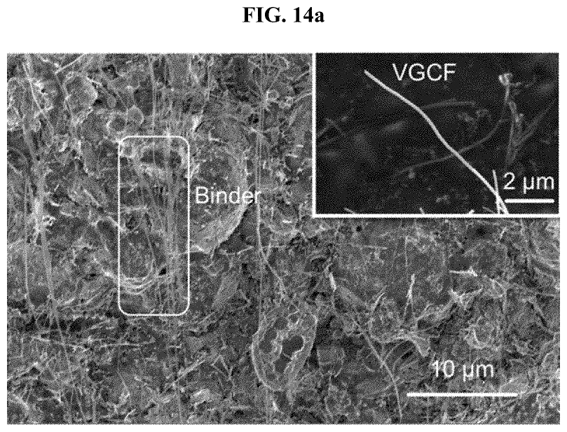

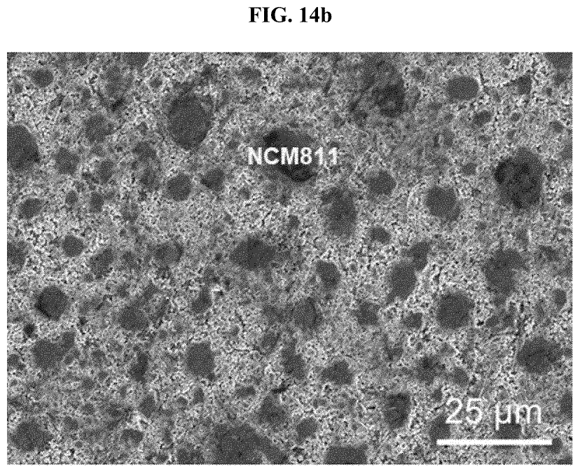

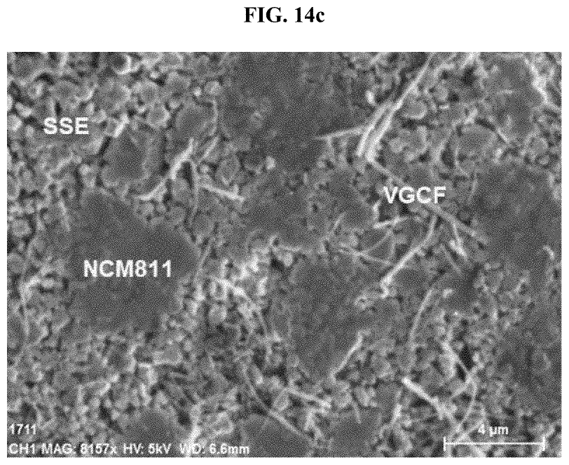

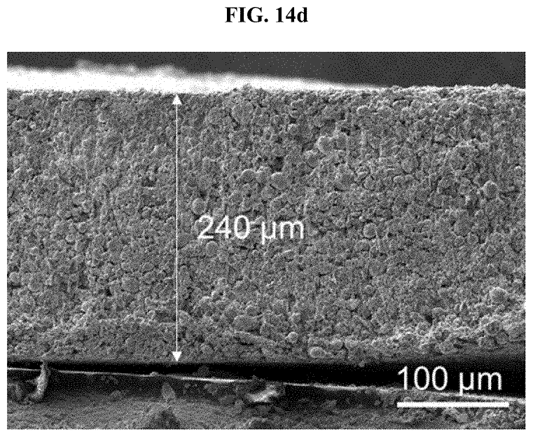

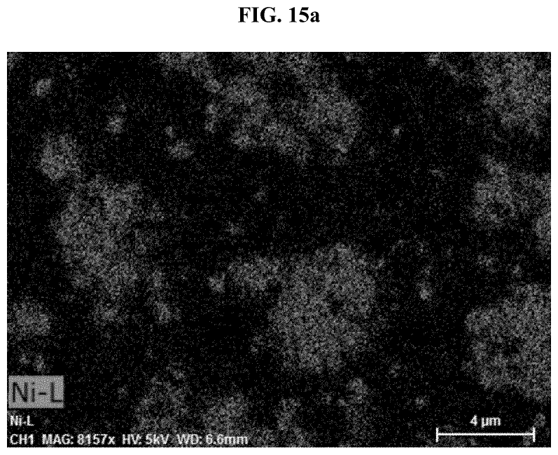

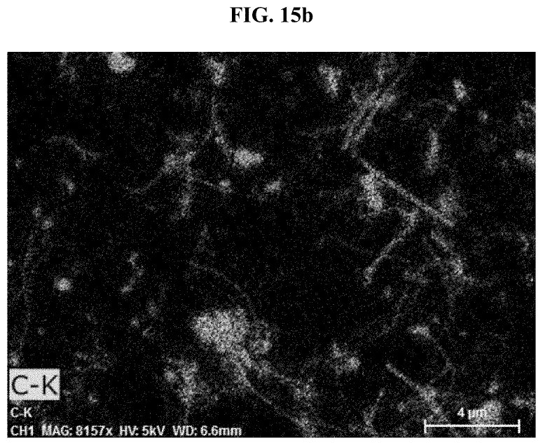

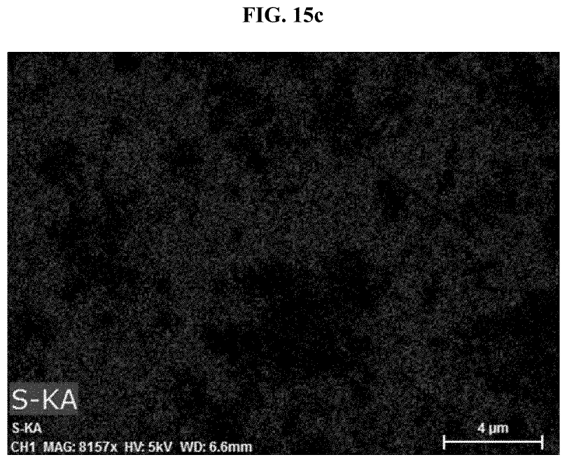

FIGS. 14a-d are SEM images of the obtained positive electrode. FIGS. 14a to 14c are top views at each scale, and FIG. 14d is a cross-sectional view. FIGS. 15a to 15c show EDS images. It is found that the positive electrode active material, the conductive material and the solid electrolyte do not agglomerate and exhibit a homogeneous dispersed phase.

3) Manufacture of Solid Electrolyte Layer

75 mg of Li₆PS₅Cl (NEI Corporation) is pressed between two titanium rods under a pressure of 370 MPa to form a 700 μm thick solid electrolyte layer.

4) Manufacture of Battery

The negative electrode, the solid electrolyte layer and the positive electrode as prepared are subjected to a pressure of 370 MPa using a titanium plunger to manufacture a battery. The titanium plunger is used as a current collector. In the battery, the NP ratio is 1.1.

### Example 1-2

A battery is manufactured by the same method as example 1-1 except that the thickness of the positive electrode is 110 μm, the loading amount is 5.5 mAh/cm² and the NP ratio is 2.4.

### Example 1-3

A battery is manufactured by the same method as example 1-1 except that the thickness of the positive electrode is 24 μm, the loading amount is 0.5 mAh/cm² and the NP ratio is 26.0.

### Example 1-4

A battery is manufactured by the same method as example 1-1 except that the Si powder, the carbon black and the binder resin are mixed at a weight ratio of 97:2:1.

### Example 2

The negative electrode manufactured in example 1-1 and a lithium metal counter electrode are used, and a solid electrolyte layer is interposed between the negative electrode and the lithium metal counter electrode to manufacture a half cell battery. The solid electrolyte layer is the same as the solid electrolyte layer of example 1-1.

### Comparative Example 1

Si powder (Alfa Aesar, particle size 3 μm to 5 μm) and a conductive material (carbon black, STREM Chemicals) are added to a solution of 0.1 wt % of PVDF (Kynar (HSV-900)) in N-Methyl-2-Pyrrolidone and mixed to prepare a negative electrode forming slurry. The concentration of solids in the slurry is about 25 wt %. In the slurry, the Si powder, the carbon black and the binder resin are mixed at a weight ratio of 79.92:19.98:0.1. The slurry is applied to a copper thin film (10 μm thick) using a doctor blade. This is dried overnight under vacuum at 80° C. to remove the solvent, and pressed under a pressure of 370 MPa so that the porosity is 33%. Subsequently, this is cut into a disc shape to obtain a negative electrode.

A positive electrode and a solid electrolyte layer are prepared by the same method as example 1-1.

The negative electrode, the solid electrolyte layer and the positive electrode as prepared are pressed under a pressure of 370 MPa using titanium plungers to manufacture a battery. The titanium plunger is used as a current collector. In the battery, the NP ratio is 1.1.

### Comparative Example 2

A negative electrode is prepared by the same method as example 1-1. A positive electrode is manufactured by adding NCM811 (LG Chem, LiNi_{0.8}Co_{0.1}Mn_{0.1}O₂), a conductive material (carbon black. STREM Chemicals), PVDF (Kynar (HSV-900)) to N-Methyl-2-Pyrrolidone at a ratio of 97:1.5:1.5 and mixing to prepare a slurry, followed by coating the slurry on an Al foil (thickness 15 μm) and drying the solvent.

The negative electrode and the positive electrode are stacked with a separator interposed between and laminated to manufacture an electrode assembly. For the separator, a polyethylene porous film (thickness 15 μm, porosity 33 vol %) is used. The electrode assembly is placed in a coin cell and a liquid electrolyte is injected to manufacture a battery. In the battery, the NP ratio is 1.1. The electrolyte solution is prepared using 1M LiPF₆ in a mixed solution of ethylene carbonate (EC) and ethylmethylcarbonate (EMC) at a volume ratio of 3:7.

### Comparative Example 3

A battery is manufactured by the same method as comparative example 2 except that lithium metal is used for the positive electrode.

2. Evaluation Results

(1) Voltage Profile

FIG. 6 shows voltage profiles of the batteries of example 1-1 and comparative example 1 during the initial lithiation. The battery of example 1-1 using no conductive material in the negative electrode shows the initial voltage plateau range at about 3.5V, but the battery of comparative example 1 shows the plateau range at 2.5V that is lower than the battery of example. It can be seen that the solid electrolyte is decomposed before 3.5V of lithiation potential.

(2) Decomposition of Solid Electrolyte (1)

XRD is performed under the condition of Cu Kα radiation (λ=1.54178 Å), 2θ (5-70°, 0.01° step size). In general, pristine electrode and repeatedly charge/discharged electrode are taken from the batteries, milled using agate mortar and pe agate mortar and pestle and put into a measurement device, and argon gas is fed. The peak of Li₂S and Li₆PS₅Cl is identified using inorganic crystal structure database (ICSD).

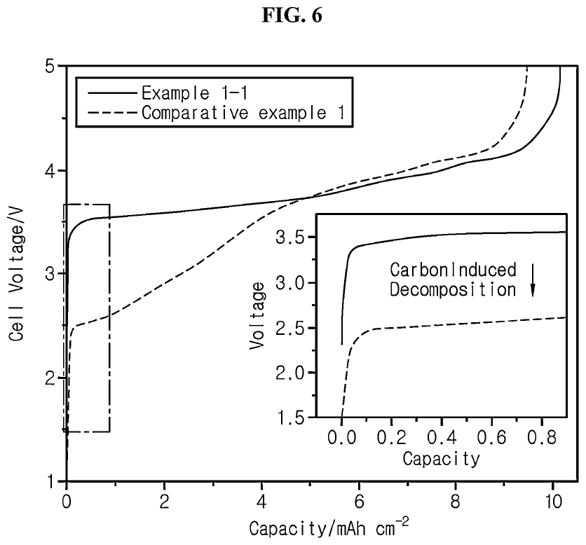

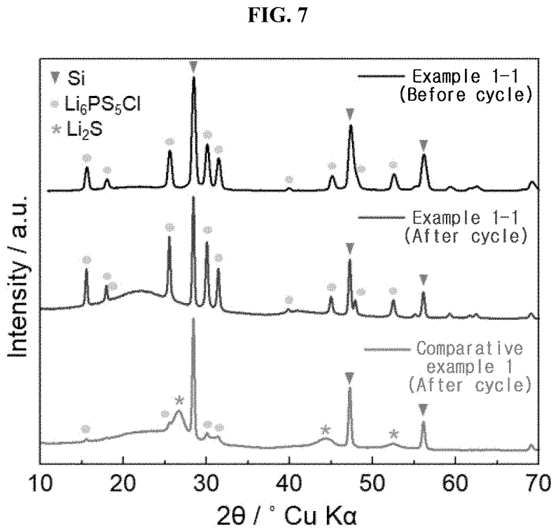

FIG. 7 shows the lithiated diffraction pattern of Si-solid electrolyte (Si-SSE) and lithiated Si-SSE of the battery of example 1-1 and lithiated diffraction pattern of comparative example 1 before cycles.

According to FIG. 7, the lithiated Si-SSE sample of example 1-1 maintains the crystallinity structure of the solid electrolyte (SSE), and shows amorphous Li—Si peak in the proximity of about 20°. Although SEI was expected, it is difficult to detect a small amount of SEI formed at the interface using this bulk technique. However, a diffraction signal of most of SSE before cycles is not observed in the battery of comparative example 1, and this shows that severe electrolyte decomposition occurred. It seems that in this process, nanocrystalline Li₂S is formed as the key by-product of electrolyte decomposition, and its wide peak is observed in the proximity of about 26°, 45° and 52°.

(3) Decomposition of Solid Electrolyte (2)

Si-SSE interface products are identified using AXIS Supra X-ray photoelectron spectroscopy (XPS) (Kratos Analytical), and it is found that there is a difference between the presence and absence of the carbon additive in the charging of the battery. In example 1-1 and comparative example 1, the binding energy of the mixture at lithium 1s, sulfur 2p and silicon 2p regions after charge (charge state) is compared with silicon-Li₆PS₅Cl before charge (pristine state). The XPS spectrum is collected using the emission current of 5 mA and 700 μm×300 μm. The spectrum is analyzed using CasaXPS software.

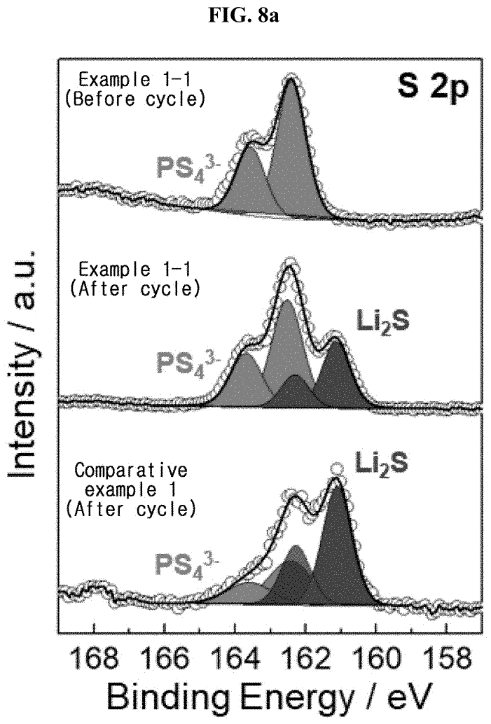

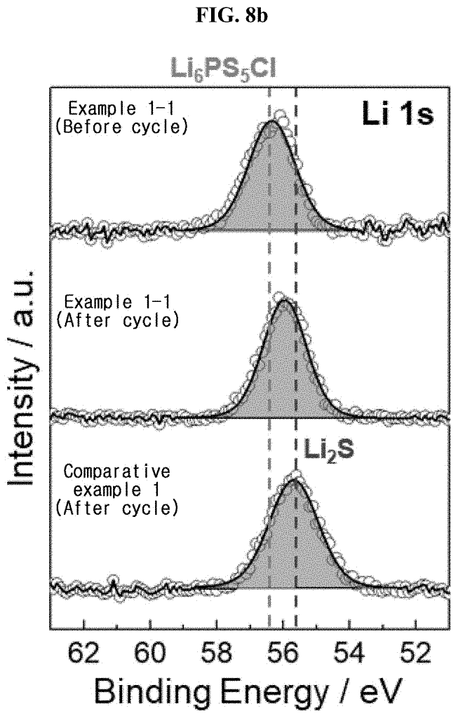

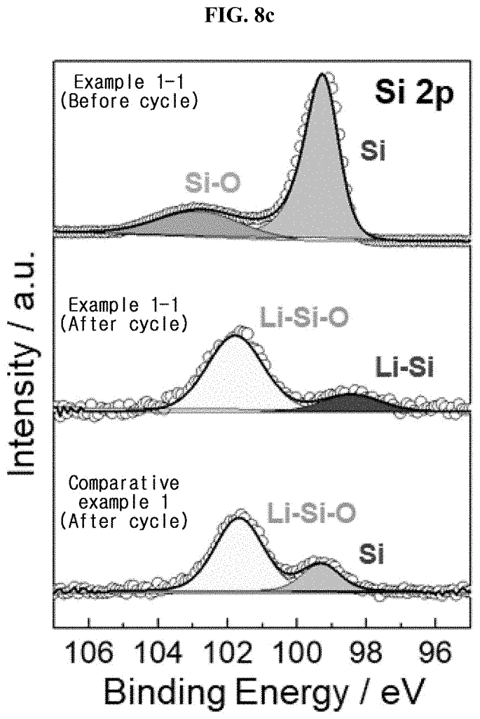

When carbon is included, it is found that the extent of decomposition of the solid electrolyte increases from formation of Li₂S (161 eV) at S 2p. A significant reduction in the peak intensity of PS4³⁻ is observed in the battery of comparative example 1 compared to the battery of example 1-1 (as shown in FIGS. 8a to 8c). Since Li is region has a variety of Li+, it is difficult to identify the peak, but shift to low binding energy is observed due to the partial reduction of the solid electrolyte after charge. In the case of example 1-1, the shift is not large, but in the case of comparative example 1, Li₂S signal is dominant at about 55.6 eV. It can be seen that the conventional XRD result is confirmed. Meanwhile, in the Si 2p region, a natural oxide layer is observed near Si particle surface. During the charge of the battery, the signal shifts to lower binding energy, resulting in lithiation. The peak of binding energy corresponding to Li—Si is found in example 1-1, and in comparative example 1, Si does not react and remains. Presumably, in comparative example 1, Li+ ion is not charged in the Si negative electrode active material and causes decomposition of the solid electrolyte and generates Li₂S. This result supports the reason that the use of carbon-based conductive material in the SSE system is eliminated. When carbon is used in the negative electrode, it is possible to increase the amount of silicon negative electrode active material up to 99.9 wt %.

(4) Quantification of SEI

SEI and Li—Si are quantified using Titration gas chromatography (TGC) method. Through example 1-1, five batteries are manufactured and charged/discharged during first to fifth cycles. Subsequently, the positive electrode is removed from each battery, the negative electrode and SSE are brought into complete reaction of Li—Si in a jar filled with argon with an addition of anhydrous ethanol to generate H₂ gas, and Li+ is quantified by TGC method using the generated gas. The amount of Li—Si derived from the quantified H₂ gas is calculated from a normalized H₂ gas calibration curve. Additionally, Coulombic efficiency % loss and SEI formed from quantified Li+ may be quantified. This is shown in FIGS. 9a and 9b.

Referring to FIGS. 9a to 9b, at the initial cycle, the formed SEI is 11.7% based on the total capacity of the battery, and at the second cycles, rises to 12.4%. In the subsequent cycles, SEI or active Li+ is kept stable and has no change, and this signifies that deactivation of the interface induces interface passivation which prevents continuous reaction between Li—Si and electrolyte.

To see the increased impedance by SEI formation, electrochemical impedance spectroscopy (EIS) is measured during 30 charge/discharge cycles of the battery of example 1-1, and the resulting voltage profile is shown in FIG. 9c. In FIG. 9c, before cycles, since SEI is formed for the first time, an increase in impedance is observed after the first cycle, and this matches the TGC analysis. Subsequently, the impedance does not increase and is stably maintained during 30 cycles, and this indicates that SEI is not formed any longer.

(5) Life Characteristics

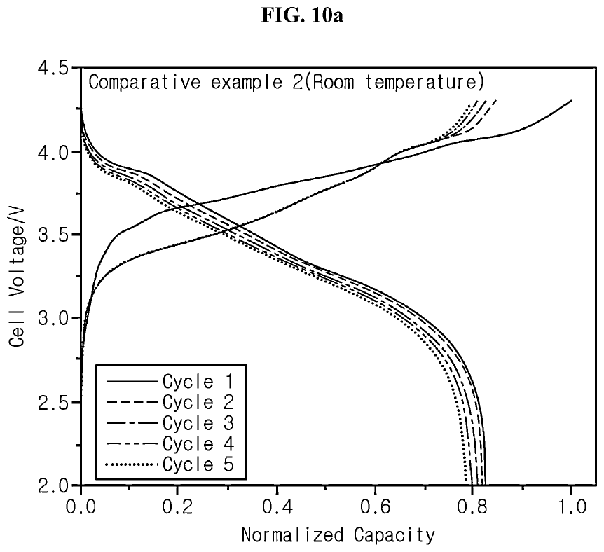

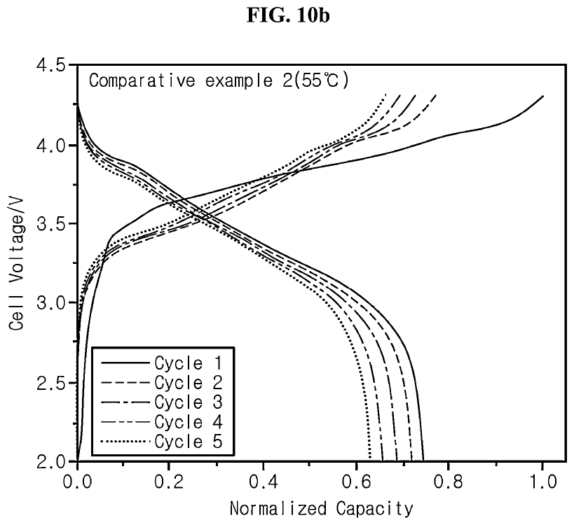

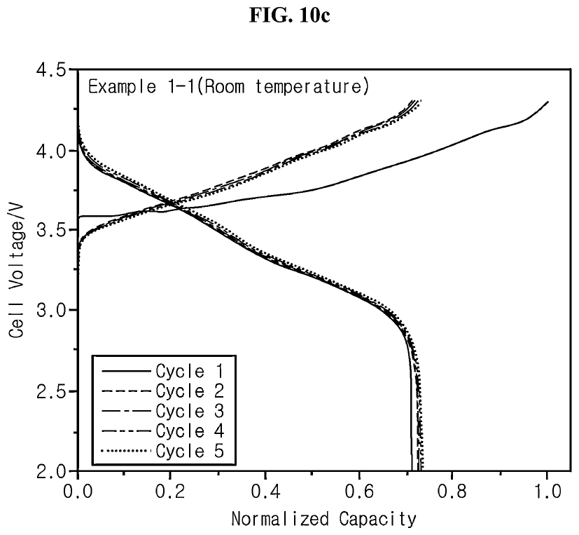

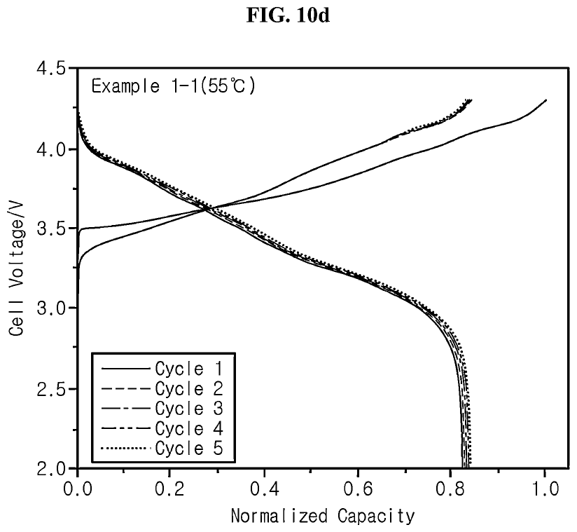

The life characteristics are compared between the battery of example 1-1 and the battery of comparative example 2 and the comparison is shown in FIGS. 10a and 10b. In the following drawings, FIGS. 10a and 10b show the life characteristics of the battery of comparative example 2 at room temperature and high temperature (55° C.), and reveal that the capacity retention decreases with the increasing cycles. In contrast, the battery of example 1-1 maintains the capacity retention during cycles at room temperature or high temperature (55° C.) (FIGS. 10c, 10d).

(6) Storage Characteristics

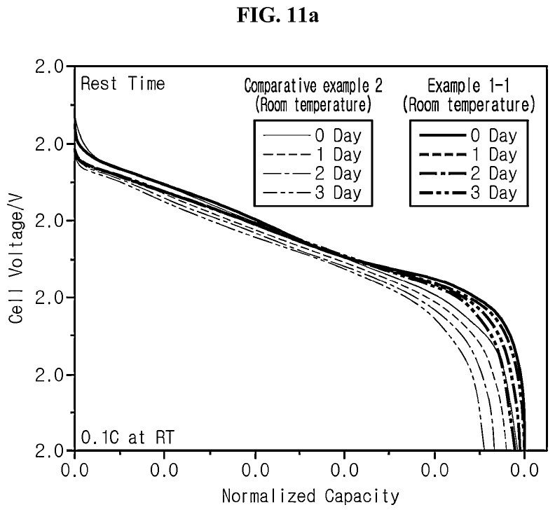

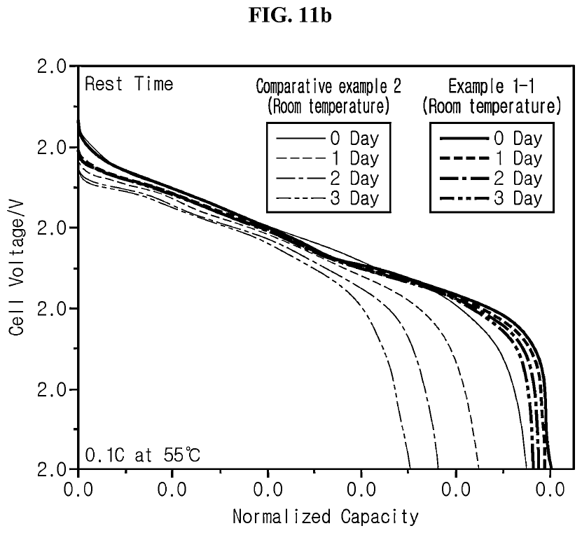

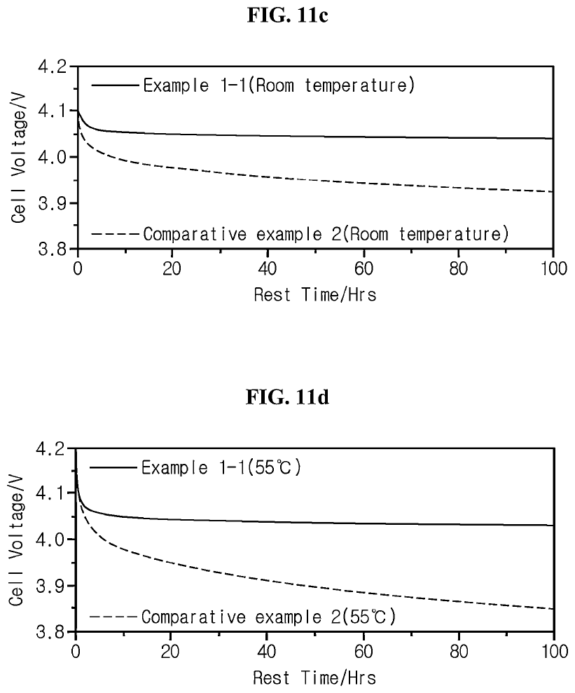

FIGS. 11a to 11d show the storage characteristics of example 1-1 and comparative example 2 at room temperature and high temperature conditions. When the fully charged batteries of example 1-1 and comparative example 2 are placed at room temperature, it is found that the battery of comparative example 2 is more likely to be discharged than the battery of the present disclosure. At 55° C., the battery of example 1-1 shows the plateau range at about 4.05V, but the battery of comparative example 2 drops down to 3.85V with the passage of 100 hours. This signifies that the carbon-based conductive material included in the negative electrode causes reduction decomposition of the solid electrolyte and the battery is self-discharged.

(7) Cross-Sectional Image

To observe volume changes as a result of decreasing porosity during the lithiation process of the porous silicon electrode of the battery, ion beam cross sectional scanning electron microscopy images are captured using FEI Scios Dualbeam. Ga+ milling is performed on the charged/discharged battery of example 1-1 using a cross-sectional cleaning process at various electric currents, and SEM-EDX imaging is performed using the function rule embedded in FEI Scios Dualbeam.

The accompanying FIG. 3a shows the pristine state, and FIG. 3b shows the fully lithiated state after cycles. At the pristine state, the negative electrode shows the porous properties due to the pores between each particle and the pore size is about 3-5 microns. At the fully lithiated state, the pores become fully filled, achieving a dense lithiated silicon metallic state with limited expansion perpendicular to the thickness wise direction of the electrode.

It seems that at the pristine state (FIG. 3a), the negative electrode remains porous with 25 to 40 vol %, and upon lithiation (FIG. 3b), volume expansion of silicon forces Si to expand into own porous, achieving a dense state with limited expansion in the Z-axis direction. This prevents excessive stresses on the SSE layer which can cause cracks to form and cells to fail.

(8) Electrochemical Performance Evaluation

For the battery of example 1-1, the EIS of the discharged battery before cycles and every six cycles is measured using Solartron 1260 impedance analyzer. The EIS applies AC potential of 30 mV in the frequency range of 1 MHz to 0.1 Hz. Additionally, charging/discharging is performed under the stack pressure of 50 MPa using Neware Battery cycler, and analyzed using BTS9000 software.

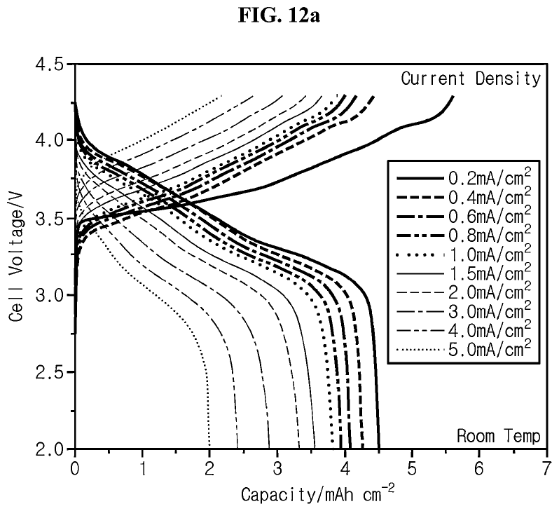

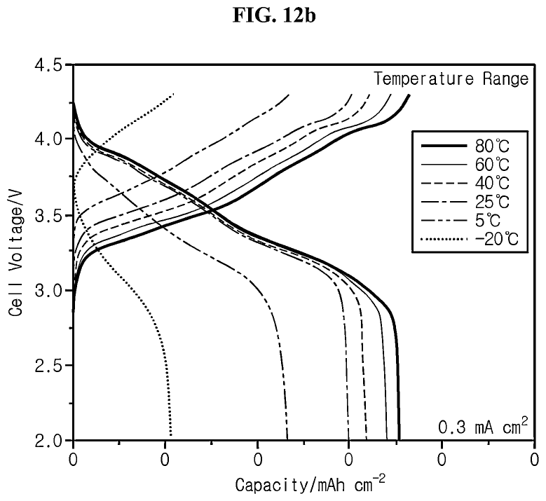

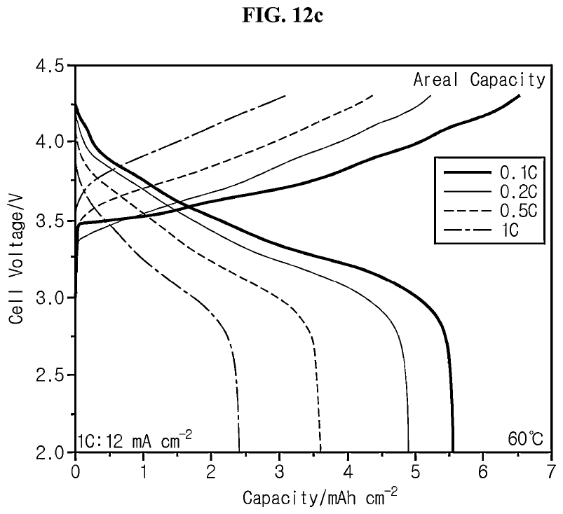

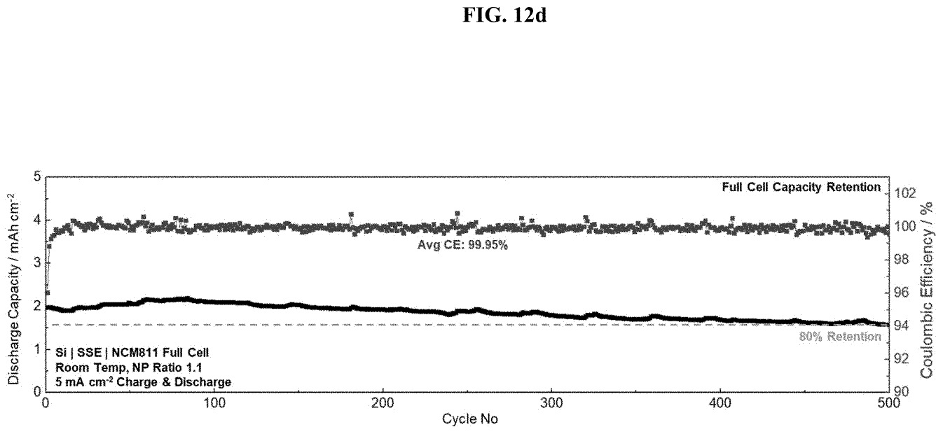

FIG. 12a shows the cycle results performed at room temperature, measured during charge/discharge with the increasing current from 0.2 mA/cm² to 5 mA/cm². At room temperature, a short circuit does not occur until 5 mA/cm². FIG. 12b shows the charge/discharge cycles with changes in temperature from −20° C. to 80° C. under the condition of about 0.3 mA/cm². It can be seen that with the rising temperature, the capacity of the battery increases. At low temperature, polarization of the battery remarkably increases, but it seems that this is caused by the Arrhenius behavior of Li+ diffusion in SSE, and a short circuit does not occur at low temperature. FIG. 12c shows the evaluation of the negative electrode having a high area loading amount, where the capacity of the positive electrode is 12 mAh/cm². Meanwhile, to overcome the bulk impedance of the positive electrode, the full cell is allowed to operate at 60° C. to improve Li+ diffusion kinetics. It can be seen that the negative electrode has the reversible capacity of 11 mAh/cm² or more under 0.1C (1.2 mAh/cm²). As a result of charging/discharging in 1C condition, the reversible capacity is 4 mAh/cm² or more. When charging/discharging continues at room temperature, it becomes an ideal operating environment of the solid state battery. According to FIG. 12d, it can be seen that after charging/discharging during 500 cycles at 5 mA/cm² at room temperature, the capacity retention is 80% and the average Coulombic efficiency is 99.95%.

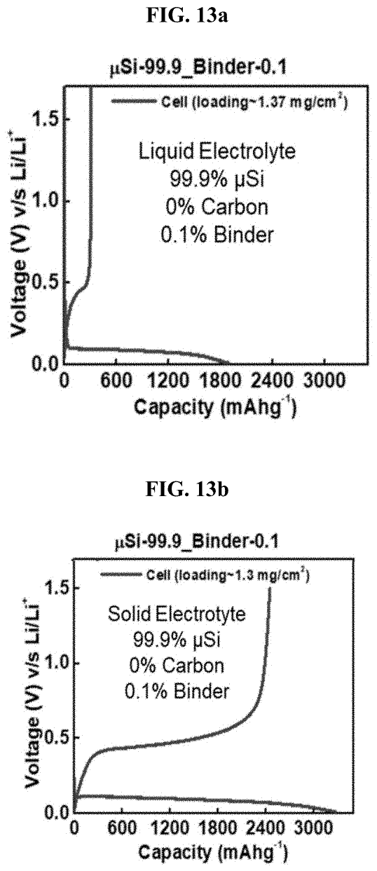

Additionally, FIG. 13a shows the charge/discharge characteristics of comparative example 3, and FIG. 13b shows the charge/discharge characteristics of the battery of example 2. For the negative electrode having the average loading amount of 1.3 mg/cm², as a result of charging/discharging at the rate of C/20, it is found that the battery of example 2 shows a clear plateau range and has better effect than the battery of comparative example 3. The battery of comparative example 3 has notable degradation of electrical and chemical properties due to the low amount of conductive material. It can be seen that the absence of carbon and binder additives in the liquid electrolyte battery causes poor capacity utilization and low first cycle Coulombic efficiency. However, in the present disclosure, in the use of sulfide-based solid electrolytes against the same Si electrode, high capacity utilization and high first cycle Coulombic efficiencies are observed.

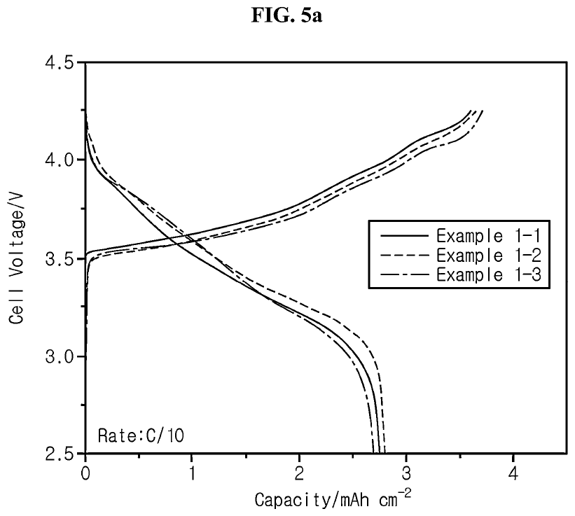

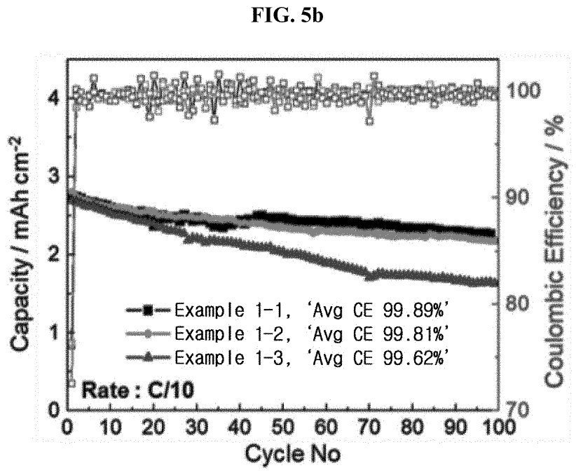

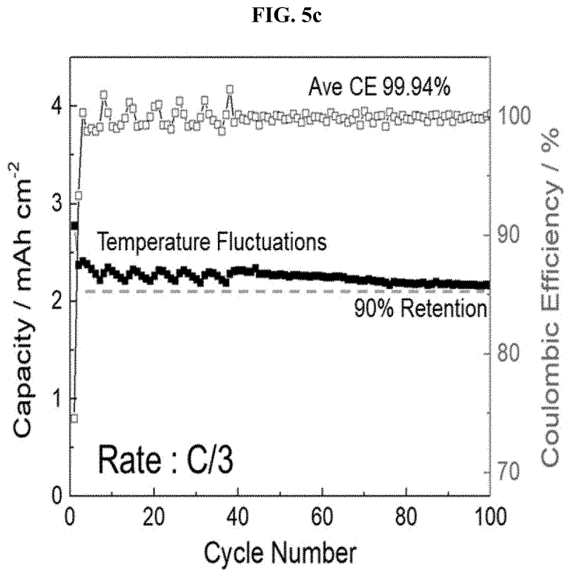

Meanwhile, FIGS. 5a to 5c show the charge/discharge characteristics and capacity characteristics of the solid state batteries having different NP ratios in example 1-1, example 1-2 and example 1-3 against the NCM811 positive electrode. In this experiment, the areal capacities of 2.5 mAh/cm² are used. FIG. 5a shows voltage profile, and FIG. 5b shows cycle performance and average Coulombic efficiency. The battery is repeatedly charged/discharged at the rate of about C/10 at room temperature, and the silicon loading amount is 0.9 mg/cm², 2.0 mg/cm² and 21.5 mg/cm² at each NP ratio. For the battery having the N/P ratio of 1.1 (comprising high Ni content NMC positive electrode and the sulfide-based solid electrolyte), by keeping the cathode capacity fixed at >2.5 mAh/cm² and lowering N/P ratio close to 1.1, average Coulombic efficiencies exceeding 99.9% with full cells are found. The rate is controlled to the rate of C/10 and C/3 under room temperature. It can be seen that all batteries cycled with more than 99% average Coulombic efficiencies per cycle, with the low NP ratio (1:1) cell cycling with more than 99.9% average Coulombic efficiencies. Meanwhile, according to FIG. 5c, for the battery of example 1-1, the current density is increased by three times from C/10 to C/3 to demonstrate high power capability and high capacity retention even at high rates. All the batteries are tested under room temperature and areal capacities of at least 2.5 mAh/cm².

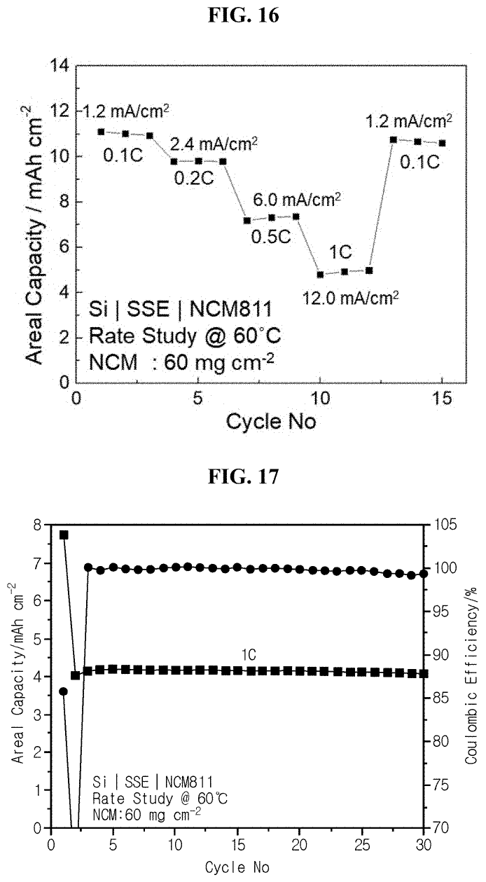

Additionally, the battery of example 1-1 is charged/discharged with varying rates, and are shown in FIG. 16. It is found that it is restored to the initial areal capacity for the same rate after repeated charge/discharge.

Meanwhile, the battery of example 1-1 is charged/discharged for 30 cycles at the rate of 1C and its results are shown in FIG. 17. It is found that there is almost no reduction in areal capacity and Coulombic efficiency even though the number of cycles increases.

(9) X-Ray Diffraction Pattern Analysis of Sulfide-Based Solid Electrolyte-Silicon (Si) Mixture

Chemical compatibility testing of sulfide-based solid electrolyte and silicon (Si) is conducted. Silicon (Si) powder and Li₆PS₅Cl are mixed at 50:50 wt %. The mixture is left to sit overnight. Subsequently, X-ray diffraction is performed using Molybdenum Ka X-ray radiation source measurements of the mixture and the results are shown in FIG. 2. It is found that the respective diffraction peaks belonging to each component is identified with no extra side products found, this is indicative of their chemical stability, and justifies their chemical compatibility.

What is claimed is:

1. A solid state battery comprising: a negative electrode, a positive electrode and a solid electrolyte layer interposed between the negative electrode and the positive electrode,
wherein the negative electrode comprises a current collector and a negative electrode active material layer,
wherein the solid electrolyte layer comprises a solid electrolyte,
wherein the negative electrode active material layer comprises silicon (Si) as a negative electrode active material,
wherein after one or more charge/discharge cycle, the negative electrode active material layer forms a Li—Si alloy having at least one columnar structure and at least one void.

2. The solid state battery according to claim 1, wherein the negative electrode active material layer further comprises at least one of lithium, conductive material, binder, and solid state electrolyte.

3. The solid state battery according to claim 1, wherein the negative electrode active material layer comprises the silicon (Si) in an amount of 75 wt % or more based on 100 wt % of the negative electrode active material layer.

4. The solid state battery according to claim 1, wherein the negative electrode active material layer comprises the silicon (Si) in an amount of 95 wt % or more based on 100 wt % of the negative electrode active material layer.

5. The solid state battery according to claim 1, wherein the negative electrode active material layer comprises the silicon (Si) in an amount of 99 wt % or more based on 100 wt % of the negative electrode active material layer.

6. The solid state battery according to claim 1, wherein the negative electrode active material layer comprises the silicon (Si) in an amount of 99.9 wt % or more based on 100 wt % of the negative electrode active material layer.

7. The solid state battery according to claim 1, wherein the silicon (Si) is present as particles having an average particle size (D50) of 0.1 μm to 10 μm.

8. The solid state battery according to claim 1, wherein the negative electrode active material layer is substantially free of conductive material.

9. The solid state battery according to claim 1, wherein the negative electrode active material layer is substantially free of solid state electrolyte.

10. The solid state battery according to claim 1, wherein the negative electrode active material layer is substantially free of binder.

11. The solid state battery according to claim 1, wherein the negative electrode active material layer comprises an interconnected and densified Li—Si alloy after one or more charge/discharge cycle.

12. The solid state battery according to claim 1, wherein the at least one void has a height that is 75-100% of the distance between the current collector of the negative electrode and the solid electrolyte layer.

13. The solid state battery according to claim 1, wherein the negative electrode active material layer comprising the Li—Si alloy has an electronic conductivity between 10⁻⁴ to 10⁻⁰ S cm⁻¹ in a discharged state.

14. The solid state battery according to claim 1, wherein the negative electrode active material layer comprising the Li—Si alloy has a density between 50-90% in a discharged state.

15. The solid state battery according to claim 1, wherein the negative electrode active material layer comprising the Li—Si alloy has a porosity between 10-50% in a discharged state.

16. The solid state battery according to claim 1, wherein the solid electrolyte is selected from the group consisting of an inorganic-based electrolyte and an organic-based electrolyte.

17. The solid state battery according to claim 16, wherein the solid electrolyte is an inorganic electrolyte selected from the group consisting of a sulfide-based solid electrolyte, an oxide-based solid electrolyte, a halide-based solid electrolyte, and a hydride-based solid electrolyte.

18. The solid state battery according to claim 17, wherein the sulfide-based solid electrolyte comprises at least one selected from LPS-based glass or glass ceramic of formula xLi₂S.yP₂S₅, wherein x+y=1, or argyrodite-based sulfide-based solid electrolyte or formula Li₆PS₅X, wherein X=Cl, Br, or I.

19. The solid state battery according to claim 1, wherein a thickness of the negative electrode active material layer follows the below formula:
$$1 \leq \frac{B}{A} \leq 1.25$$
wherein A is a thickness of the negative electrode active material layer after N charge/discharge cycles, wherein N is an integer, B is a thickness of the negative electrode active material layer after N+100 charge/discharge cycle.

20. The solid state battery according to claim 1, wherein the negative electrode active material layer in a discharged state comprises the Li—Si alloy having the at least one columnar structure and the at least one void,
wherein the Li—Si alloy has an interfacial layer at least partially in contact with the solid electrolyte, and
wherein the at least one void is located between the current collector and the interfacial layer.

21. A solid state battery comprising: a negative electrode, a positive electrode and a solid electrolyte layer interposed between the negative electrode and the positive electrode,
wherein the negative electrode comprises a current collector and a negative electrode active material layer,
wherein prior to charge and discharge of the battery, the negative electrode active material layer comprises silicon (Si) as a negative electrode active material,
wherein after a charge/discharge cycle, the negative electrode active material layer forms a Li—Si alloy having at least one columnar structure and at least one void, and
wherein after operation of the battery for 200 cycles, a change in a thickness of the negative electrode active material layer at the discharged state is less than 25%.

22. A method for manufacturing the solid state battery according to claim 21, comprising providing a negative electrode, a positive electrode and a solid electrolyte layer interposed between the negative electrode and the positive electrode,
wherein the negative electrode comprises a negative electrode active material layer comprising silicon (Si) as a negative electrode active material in an amount of 75 wt % or more based on 100 wt % of the negative electrode active material layer.

23. A solid state battery comprising: a negative electrode, a positive electrode and a solid electrolyte layer interposed between the negative electrode and the positive electrode,
wherein the negative electrode comprises a current collector and a negative electrode active material layer,
wherein the solid electrolyte layer comprises a solid electrolyte,
wherein the negative electrode active material layer comprises silicon (Si) as a negative electrode active material in amount of 75 wt % or more based on 100 wt % of the negative electrode active material layer, and
wherein the negative electrode active material layer is substantially free of solid state electrolyte.

24. The solid state battery according to claim 23, wherein the negative electrode active material layer further comprises at least one of lithium, conductive material, and binder.

25. The solid state battery according to claim 23, wherein the negative electrode active material layer comprises the silicon (Si) in an amount of 95 wt % or more based on 100 wt % of the negative electrode active material layer, an amount of 99 wt % or more based on 100 wt % of the negative electrode active material layer, or an amount of 99.9 wt % or more based on 100 wt % of the negative electrode active material layer.

26. The solid state battery according to claim 23, wherein after one or more charge/discharge cycle, the negative electrode active material layer forms a Li—Si alloy having at least one columnar structure and at least one void.

27. The solid state battery according to claim 26, wherein the at least one void has an average height that is 75-100% of the distance between the current collector of the negative electrode and the solid electrolyte layer.

28. The solid state battery according to claim 26, wherein the negative electrode active material layer comprising the Li—Si alloy in a discharged state has an electronic conductivity between 10⁻⁴ to 10⁻⁰ S cm⁻¹, a density between 50-90%, or a porosity between 10-50%.

29. The solid state battery according to claim 23, wherein the solid electrolyte is selected from the group consisting of an inorganic based electrolyte and an organic based electrolyte.

30. The solid state battery according to claim 29, wherein the solid electrolyte is the inorganic electrolyte, which inorganic electrolyte is selected from the group consisting of a sulfide-based solid electrolyte, an oxide-based solid electrolyte, a halide-based solid electrolyte, and a hydride-based solid electrolyte.

31. The solid state battery according to claim 30, wherein the inorganic electrolyte is the sulfide-based solid electrolyte, which sulfide-based solid electrolyte comprises at least one selected from LPS-based glass or glass ceramic of formula xLi₂S.yP₂S₅, wherein x+y=1, or argyrodite-based sulfide-based solid electrolyte or formula Li₆PS₅X, wherein X=Cl, Br, or I.
